(19) United States
(12) Patent Application Publication
(10) Pub. No.: US 2024/0198490 A1
(43) Pub. Date: Jun. 20, 2024

(54) APPARATUS, SYSTEM, AND METHOD FOR THREADING, GROOVING, AND BEVELING A WORKPIECE

(71) Applicant: Revolution Machine Tools, Inc., North Salt Lake, UT (US)

(72) Inventors: Kyle JORGENSON, Taylorsville, UT (US); Jaime ANAYA, North Salt Lake, UT (US)

(21) Appl. No.: 18/540,573

(22) Filed: Dec. 14, 2023

Related U.S. Application Data
(60) Provisional application No. 63/433,010, filed on Dec. 15, 2022.

(51) Int. Cl. B25B 1/02; B25B 1/10

(52) U.S. Cl. CPC B25B 1/02; B25B 1/10

(57) ABSTRACT

An apparatus, system, and method are disclosed for retaining a workpiece. In certain implementations, the apparatus may include a first jaw configured to engage a workpiece from a first side of the workpiece. In addition, the apparatus may include a second jaw configured to engage the workpiece from a second side of the workpiece, the second side opposite the first side. The apparatus may include a jaw positioner configured to move at least one of the first jaw and the second jaw laterally to engage and retain the workpiece in a stationary position, the jaw positioner having a lateral adjustment apparatus configured to counteract ovality at an end of the workpiece.

### CROSS-REFERENCE TO RELATED APPLICATIONS

This application claims the benefit of U.S. Provisional Application No. 63/433,010, filed Dec. 15, 2022, which is hereby incorporated by reference in its entirety.

### TECHNICAL FIELD

The present disclosure relates to milling machines. More specifically, the present disclosure relates to milling machines for milling cylindrical workpieces.

### BACKGROUND

Many of today's factories and industries rely on machines that enable the smooth operation of the factory and/or industrial enterprise. In many industries large machines are used to machine and shape parts for use in a production line, a drilling operation, a mining operation, a pipeline, and the like. For certain projects, one part or component needs to be machined to form a machining feature on the part or component.

Many products or components can include one or more machining steps as part of the fabrication process that form one or more machining features on a workpiece. Certain machining operations can be done on smaller workpieces by translating or rotating the workpiece.

In other applications, the part that needs to receive a machining feature may be larger than a few inches in diameter. Furthermore, the part may be connected to one or more other components such that translation and/or rotation of such a workpiece is impractical or impossible. In particular, in a mining industry or oil and gas industry, or other such industry, the operation may require the creation of one or more machining features (e.g., threads, grooves, bevels, and/or the like) on an end of a solid bar, on the inner wall of a pipe, on an outer wall of a pipe or on a disconnected end of a pipe. When the workpiece is a pipe and the machining feature is to be formed on or near an end of the pipe, translating and/or rotating the workpiece to form the machining feature can be impractical and/or impossible (e.g., a pipe end connected to tens, hundreds, or thousands of feet of pipe, some of which may be buried).

In such cases, material from the workpiece. Lathes may be suitable for small workpieces of diameters of a few inches or lengths of a few feet. However, with larger workpieces rotating the workpiece to machine the workpiece can become impractical.

Mills rotate a cutting tool either about its own axis or about one or more axes of the workpiece to remove material for a machining operation and to form a machining feature. With a mill, the workpiece is stationary and the cutting tool moves. Typically, mills rely on the workpiece being symmetrical about a longitudinal axis of the workpiece and accurately aligned with the cutting tool. If the workpiece is not symmetrical about a longitudinal axis the machining feature formed in or on the workpiece may not meet required specifications.

One challenge when machining a cylindrical workpiece, such as a pipe, is how accurately and/or precisely the pipe or solid cylindrical workpiece meets expected dimensions and/or configurations. With a pipe workpiece, the inner diameter may not be the same for each pair of opposite points around an inner wall of a cross section of the pipe. Similarly, the outer diameter may not be the same for each pair of opposite points around an outer surface of a cross section of the pipe. Said another way, an end of a pipe or solid workpiece may not be truly round, truly circular or may have some degree or percentage of ovality or non-circularity. This difference may be due to ovality and/or to irregularities in the thickness of walls of a pipe.

The present disclosure provides a milling machine that counteracts, minimizes, mitigates, compensates for, or removes, ovality and forms threads, grooves, and bevels in a workpiece such as a pipe end or solid cylinder that has ovality at the pipe end where the machining feature is formed. Existing solutions for machining machining features in, or on, the end of a workpiece such as a pipe or bar or other cylindrical workpiece are inadequate and lacking.

### SUMMARY

The various apparatuses, devices, systems and methods of the present disclosure have been developed in response to the present state of the art, and in particular, in response to the problems and needs in the art that have not yet been fully solved by currently available apparatuses, devices, systems, and/or methods.

In one general aspect, the apparatus may include a first jaw configured to engage a workpiece from a first side of the workpiece. The apparatus may also include a second jaw configured to engage the workpiece from a second side of the workpiece, the second side opposite the first side.

The apparatus may furthermore include a jaw positioner configured to move at least one of the first jaw and the second jaw laterally to engage and retain the workpiece in a stationary position, the jaw positioner having a lateral adjustment apparatus configured to counteract ovality at an end of the workpiece.

Implementations may include one or more of the following features. An apparatus where the lateral adjustment apparatus may include: a linear actuator configured to extend a jaw and to retract the jaw horizontally along a horizontal x-axis; and a plurality of fasteners configured to secure a jaw baseplate of the jaw to a slidable jaw member translatable by the jaw positioner.

An apparatus where the linear actuator is a leadscrew and is configured to move the jaw along the horizontal x-axis towards the center point to increase a lateral force on the workpiece and shorten a major axis that defines ovality at an end of the workpiece.

An apparatus where the linear actuator is a leadscrew and is configured to move the jaw along the horizontal x-axis away from the center point to decrease a lateral force on the workpiece and increase a minor axis that defines ovality at an end of the workpiece.

An apparatus may include a vertical adjustment apparatus configured to counteract ovality at an end of the workpiece.

An apparatus where the jaw positioner may include a gross adjustment apparatus and a fine adjustment apparatus, the fine adjustment apparatus having the vertical adjustment apparatus and the lateral adjustment apparatus.

In one general aspect, the apparatus may include a programmable controller configured to form a machining feature on a workpiece.

The apparatus may also include a housing having: a chuck having: a center point; a vertical y-axis that extends vertically from the center point; an x-axis that extends horizontally from the center point; an x-axis plate coupled to the chuck and configured to move laterally relative to the center point and configured to couple to at least one cutting tool.

The apparatus may furthermore include a first driver coupled to the chuck and configured to rotate the chuck about a z-axis of the chuck in response to a first control signal from the programmable controller, the z-axis extending perpendicular to the x-axis and perpendicular to the y-axis. The apparatus may in addition include a second driver coupled to the x-axis plate and configured to move the x-axis plate laterally relative to the center point in response to a second control signal from the programmable controller.

The apparatus may moreover include a third driver configured to move the chuck along the z-axis in response to a third control signal from the programmable controller.

The apparatus may also include a vise having: a first jaw configured to engage the workpiece from a first side of the workpiece; a second jaw configured to engage the workpiece from a second side of the workpiece, the second side opposite the first side; and a jaw positioner configured to move at least one of the first jaw and the second jaw laterally to engage and retain the workpiece in a stationary position, the jaw positioner having a lateral adjustment apparatus configured to counteract ovality at an end of the workpiece.

Implementations may include one or more of the following features. An apparatus where the lateral adjustment apparatus may include: a linear actuator configured to extend and to retract a jaw horizontally along the x-axis; a stationary member configured to maintain a position of the linear actuator along the x-axis as the linear actuator operates; and a plurality of fasteners configured to secure a jaw baseplate of the jaw to a slidable jaw member translatable by the jaw positioner.

An apparatus where the linear actuator is configured to move the jaw along the x-axis towards the center point to increase a lateral force on the workpiece and shorten a major axis that defines ovality at an end of the workpiece.

An apparatus where the linear actuator is configured to move the jaw along the x-axis away from the center point to decrease a lateral force on the workpiece and increase a minor axis that defines ovality at an end of the workpiece.

An apparatus may include a vertical adjustment apparatus configured to counteract ovality at an end of the workpiece.

An apparatus where the jaw positioner may include a gross adjustment apparatus and a fine adjustment apparatus, the fine adjustment apparatus having the vertical adjustment apparatus and the lateral adjustment apparatus. An apparatus where the housing and the vise are coupled to a frame such that the apparatus may include a single portable unit and where the lateral adjustment apparatus and the vertical adjustment apparatus each may include a mechanical system.

An apparatus where the gross adjustment apparatus is configured to position the workpiece such that a longitudinal axis of the workpiece is coaxial with the z-axis. An apparatus where the first jaw and the second jaw are both coupled to a gross adjustment apparatus of the jaw positioner, such that activation of the gross adjustment apparatus translates both the first jaw and the second jaw together. An apparatus may include a frame coupled to the vise and to the housing and to the third driver.

An apparatus where the x-axis plate is coupled to two or more cutting tools and the programable controller is configured to direct one of the cutting tools to cut into the workpiece for a first stage of a cutting operation and to direct another one of the cutting tools to cut into the workpiece for a second stage of the cutting operation.

An apparatus where the vise may include a v-axis that extends through the first jaw and the second jaw and runs parallel to the x-axis, the v-axis configured to represent a zero-return position for the vise.

In one general aspect, the apparatus may include a programmable controller configured to form a machining feature on a workpiece by following G and M software executable codes configured for the machining feature.

The apparatus may also include a housing having: a chuck having: a center point; a vertical y-axis that extends vertically from the center point; a horizontal x-axis that extends horizontally from the center point; an x-axis plate coupled to the chuck and configured to move laterally relative to the center point and configured to couple to a cutting tool configured to form the machining feature.

The apparatus may furthermore include a first driver coupled to the chuck and configured to rotate the chuck about a z-axis of the chuck in response to a first control signal from the programmable controller, the z-axis extending perpendicular to the x-axis and perpendicular to the y-axis. The apparatus may in addition include a second driver coupled to the x-axis plate and configured to move the x-axis plate laterally relative to the center point in response to a second control signal from the programmable controller. The apparatus may moreover include a third driver configured to move the chuck along the z-axis in response to a third control signal from the programmable controller.

The apparatus may also include a vise having: a first jaw configured to engage the workpiece from a first side of the workpiece; a second jaw configured to engage the workpiece from a second side of the workpiece, the second side opposite the first side; a gross adjustment apparatus configured to move the first jaw and the second jaw laterally to engage and retain the workpiece in a stationary position; a fine adjustment apparatus configured to counteract ovality at an end of the workpiece, the fine adjustment apparatus having: a vertical adjustment apparatus configured to adjust a grip of the vise on the workpiece along the y-axis; a lateral adjustment apparatus configured to adjust the grip of the vise on the workpiece along the x-axis.

Implementations may include one or more of the following features. An apparatus where the vertical adjustment apparatus may include a first vertical adjustment apparatus configured to adjust the first jaw independent of a second vertical adjustment apparatus configured to adjust the second jaw.

### BRIEF DESCRIPTION OF THE DRAWINGS

The advantages, nature, and additional features of exemplary embodiments of the disclosure will become more fully apparent from the following description and appended claims, taken in conjunction with the accompanying drawings. Understanding that these drawings depict only exemplary embodiments and are, therefore, not to be considered limiting of the disclosure's scope, the exemplary embodiments of the disclosure will be described with additional specificity and detail through use of the accompanying drawings.

FIG. 1 is a side view illustrating one embodiment of a system for threading, grooving, and beveling according to one embodiment.

FIG. 2 is a side view illustrating another embodiment of a system for threading, grooving, and beveling, according to one embodiment.

FIGS. 3A-3D are perspective views of one embodiment of a system for threading, grooving, and beveling, according to one embodiment.

FIG. 4A is a front view illustrating one embodiment of a system for threading, grooving, and beveling, according to one embodiment.

FIG. 4B illustrates an example of ovality of an end of a workpiece, according to one embodiment.

FIG. 4C illustrates an example control panel or user interface according to one embodiment.

FIG. 4D illustrates an example control panel or user interface according to one embodiment.

FIG. 5A is a close-up view illustrating a lateral adjustment apparatus according to one embodiment.

FIG. 5B is a close-up view illustrating a lateral adjustment apparatus according to one embodiment.

FIG. 6 is a perspective view illustrating a cutting face with tooling of a system for threading, grooving, and beveling, according to one embodiment.

FIG. 7A-7C is a perspective view, top view, and end view respectively of a cutting tool, according to one embodiment.

### DETAILED DESCRIPTION

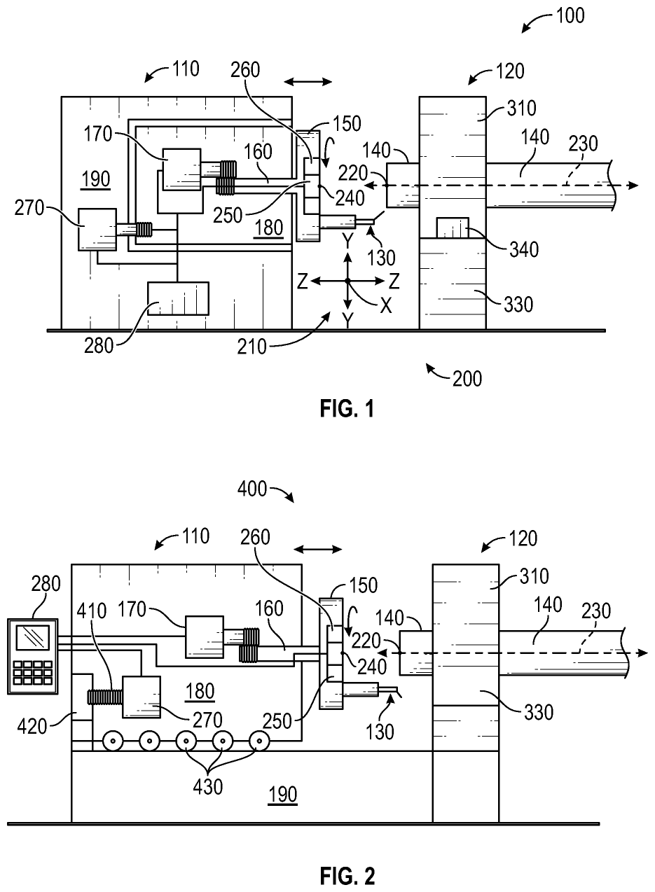

Exemplary embodiments of the disclosure will be best understood by reference to the drawings, wherein like parts are designated by like numerals throughout. It will be readily understood that the components, as generally described and illustrated in the Figures herein, could be arranged and designed in a wide variety of different configurations. Thus, the following more detailed description of the embodiments of the apparatus, system, and method, as represented in FIGS. 1 through 6C, is not intended to limit the scope of the disclosure but is merely representative exemplary of exemplary embodiments.

“Motor” refers to a device, apparatus, member, component, system, assembly, module, subsystem, circuit, or structure, that is organized, configured, designed, arranged, or engineered to convert energy forms into mechanical energy. (Search “motor” on wordhippo.com. WordHippo, 2022. Web. Accessed 30 Mar. 2022. Modified.) Examples of motors include, but are not limited to, electric motors, internal combustion chamber motors, and the like.

As used herein, a “drive” refers to an apparatus, instrument, structure, device, component, system, or assembly structured, organized, configured, designed, arranged, or engineered to receive a torque and transfer that torque to a structure connected or coupled to the drive. At a minimum, a drive is a set of shaped cavities and/or protrusions on a structure that allows torque to be applied to the structure. Often, a drive includes a mating tool, known as a driver. For example, cavities and/or protrusions on a head of a screw are one kind of drive and an example of a corresponding mating tool is a screwdriver, that is used to turn the screw, the drive. Examples of a drive include but are not limited to screw drives such as slotted drives, cruciform drives, square drives, multiple square drives, internal polygon, internal hex drives, pentalobular sockets, hexalobular sockets, combination drives, external drives, tamper-resistant drives, and the like. (Search ‘list of screw drives’ on Wikipedia.com Mar. 12, 2021. Modified. Accessed Mar. 19, 2021.)

As used herein, a “driver” refers to a mechanical piece, component, or structure for imparting motion to another piece, component, or structure. (“driver.” Merriam-Webster.com. Merriam-Webster, 2021. Web. 6 Jan. 2021. Modified.) In certain embodiments, a driver can be a wheel configured or connected to other parts such that rotation or motion of the driver causes motion of other interconnected or intercoupled parts (e.g., gears, axles, shafts, rods, chains, pulleys, or the like) of a component, system, apparatus, or device. A driver can be a mechanical assembly, a simple machine, and/or a motor. A driver can be an electric motor, a stepper motor, an internal combustion motor, or the like. A driver may also be referred to as a drive motor.

“Control signal” refers to an electrical signal (wired or wireless) designed, engineered, and/or provided to control, manage, direct, instruct, or monitor another component, device, circuit, apparatus, system, and/or assembly.

As used herein, “side” refers to a structure or part of a structure including, but not limited to: one of a longer bounding surfaces or lines of an object especially contrasted with the ends, a line or surface forming a border or face of an object, either surface of a thin object, a bounding line or structure of a geometric figure or shape, and the like. (search “side” on Merriam-Webster.com. Merriam-Webster, 2021. Web. 3 Aug. 2021. Modified.) A side can also refer to a geometric edge of a polygon (two-dimensional shape) and/or a face or surface of a polyhedron (three-dimensional shape). (Search “side” on Wikipedia.com Jul. 21, 2021. CC-BY-SA 3.0 Modified. Accessed Aug. 3, 2021.) Side can also refer to a location on a structure. For example, a side can be a location on a structure at, or near, a furthest position away from a central axis of the structure. As used herein, the term “side” can include one or more modifiers that define and/or orient and/or distinguish the side of an object from others based on where and/or how the object is deployed within or in relation to a second object.

“Mechanical system” refers to an apparatus, instrument, structure, device, component, member, system, assembly or module structured, organized, configured, designed, arranged, or engineered to perform one or more features, functions, and/or operations using some, most, or wholly mechanical components, linkages, couplings, connections, and the like. In certain embodiments, a mechanical system may include no electrical, pneumatic, or hydraulic components.

“Elbow pipe” refers to a length of pipe having a first end and a second end, the first end is connected to a length of pipe that traverses an angle of less than 180 degrees measured in relation to a longitudinal axis of the first end, the length of pipe ending at the second end. In some embodiments, an elbow pipe is a fitting or adapter that connects one or more straight lengths of pipe.

As used herein, a “body” refers to a main or central part of a structure. The body may serve as a structural component to connect, interconnect, surround, enclose, and/or protect one or more other structural components. A body may be made from a variety of materials including, but not limited to, metal, plastic, ceramic, wood, fiberglass, acrylic, carbon, biocompatible materials, biodegradable materials or the like. A body may be formed of any biocompatible materials, including but not limited to biocompatible metals such as Titanium, Titanium alloys, stainless steel alloys, cobalt-chromium steel alloys, nickel-titanium alloys, shape memory alloys such as Nitinol, biocompatible ceramics, and biocompatible polymers such as Polyether ether ketone (PEEK) or a polylactide polymer (e.g. PLLA) and/or others. In one embodiment, a body may include a housing or frame or framework for a larger system, component, structure, or device. A body may include a modifier that identifies a particular function, location, orientation, operation, and/or a particular structure relating to the body. Examples of such modifiers applied to a body, include, but are not limited to, “inferior body,” “superior body,” “lateral body,” “medial body,” and the like.

“Position” refers to a place or location. (Search “position” on wordhippo.com. WordHippo, 2022. Web. Modified. Accessed 9 Aug. 2022.) Often, a position refers to a place or location of a first object in relation to a place or location of another object. One object can be positioned on, in, or relative to a second object. In addition, a position can refer to a place or location of a first object in relation to a place or location of another object in a virtual environment. For example, a model of one object can be positioned relative to a model of another object in a virtual environment such as a modeling software program.

“Stage” refers to a portion, part, or segment of an operation. Steps performed in one stage may be required before steps in a subsequent stage in order to accomplish a goal of an operation that includes multiple stages. Often an operation will include two or more stages.

“Fastener”, “fixation device”, or “fastener system” refers to any structure configured, designed, or engineered to join two structures. Fasteners may be made of a variety of materials including metal, plastic, composite materials, metal alloys, plastic composites, and the like. Examples of fasteners include, but are not limited to screws, rivets, bolts, nails, snaps, hook and loop, set screws, bone screws, nuts, posts, pins, thumb screws, and the like. Other examples of fasteners include, but are not limited to wires, anchors, plates, rods or pins, implants, sutures, soft sutures, soft anchors, tethers, interbody cages, fusion cages, and the like. In certain embodiments, the term fastener may refer to a fastener system that includes two or more structures configured to combine to serve as a fastener. An example of a fastener system is a rod or shaft having external threads and an opening or bore within another structure having corresponding internal threads configured to engage the external threads of the rod or shaft. In certain embodiments, the term fastener may be used with an adjective that identifies an object or structure that the fastener may be particularly configured, designed, or engineered to engage, connect to, join, contact, or couple together with one or more other structures of the same or different types. For example, a “metal fastener” may refer to an apparatus for joining or connecting one or more metal structures, or the like. In certain embodiments, a fastener may be a temporary fastener. A temporary fastener is configured to engage and serve a fastening function for a relatively short period of time. Typically, a temporary fastener is configured to be used until another procedure, stage, or operation is completed and/or until a particular event. In certain embodiments, a user may remove or disengage a temporary fastener. Alternatively, or in addition, another structure, event, or machine may cause the temporary fastener to become disengaged.

“Frame” refers to a structure organized, configured, designed, arranged, or engineered to provide structural support to one or more other devices, structure, components, and/or elements. In general a frame is rigid and provides structural support to one or more other components coupled to, integrated with, interfacing with, or connected to the frame. A frame may be a unitary component or a frame may be made up of a plurality of components.

As used herein, a “housing” refers to a structure that serves to connect, interconnect, surround, enclose, and/or protect one or more other structural components. A housing may be made from a variety of materials including, but not limited to, metal, plastic, ceramic, wood, fiberglass, acrylic, carbon, or the like. Often a housing is made from plastic due to its lower expense, strength, and durability. A housing may also be formed of any materials, including but not limited to metals such as Aluminum, Steel, Carbon Fiber, Titanium, Titanium alloys, stainless steel alloys, cobalt-chromium steel alloys, nickel-titanium alloys, shape memory alloys and/or others. A housing may include a frame or framework or function within a larger system, component, structure, or device.

“Longitudinal axis” refers to an axis of a structure, device, object, apparatus, or part thereof that extends from one end of a longest dimension to an opposite end. Typically, a longitudinal axis passes through a center of the structure, device, object, apparatus, or part thereof along the longitudinal axis. The center point used for the longitudinal axis may be a geometric center point and/or a mass center point.

“Center point” refers to a geometric center of a structure, object, part, component, sub-assembly, or apparatus. Where the structure is a circle or sphere, the center point is the middle point of the structure, a point equidistant from every point on the circumference or surface. (Search “define center” on google.com. Oxford Languages, 2022. Modified. Accessed 11 Oct. 2022.) In certain structures, the center point and/or a mass center point may be the same point.

“Controller” refers to any hardware, device, component, element, or circuit configured to manage, implement, or control the features, functions, and/or logic for a device, component, apparatus, or system, and may comprise one or more processors, onboard memory, registers, cores, programmable processors (e.g., FPGAs), programmable logic devices, complex programmable logic devices (CPLD), mixed-signal CPLDs, ASICs, micro-controllers (MCU), electronic circuits, or the like. A controller may execute one or more of predefined software in the form of microcode, firmware, embedded state machine code, scripts, and/or the like.

As used herein, “side” refers to a structure or part of a structure including, but not limited to: one of a longer bounding surfaces or lines of an object especially contrasted with the ends, a line or surface forming a border or face of an object, either surface of a thin object, a bounding line or structure of a geometric figure or shape, and the like. (search “side” on Merriam-Webster.com. Merriam-Webster, 2021. Web. 3 Aug. 2021. Modified.) A side can also refer to a geometric edge of a polygon (two-dimensional shape) and/or a face or surface of a polyhedron (three-dimensional shape). (Search “side” on Wikipedia.com Jul. 21, 2021. CC-BY-SA 3.0 Modified. Accessed Aug. 3, 2021.) Side can also refer to a location on a structure. For example, a side can be a location on a structure at, or near, a furthest position away from a central axis of the structure. As used herein, the term “side” can include one or more modifiers that define and/or orient and/or distinguish the side of an object from others based on based on where and/or how the object is deployed within or in relation to a second object.

“Software” refers to any form of instructions that a machine or device can accept and can implement the features, functions, or operations specified in the instructions. Software include both machine-readable instructions, human readable instructions, and instructions that are both human and machine readable. Examples of software include, but are not limited to, binary code, machine code, microcode, firmware, scripts, compiled code, source code, and the like.

“Cutting tool” refers to a structure, object, apparatus, or device configured to form, shape, or cut into a second object by cutting into, abrading, wearing, or otherwise removing material from the second object. A cutting tool can refer to a manual or power tool for cutting or resecting the second object. The cutting function may be accomplished by moving either the cutting tool, or a blade, or one or more teeth of the cutting tool in contact with the second object while holding the second object stationary. Alternatively, the cutting tool or blades or teeth of the cutting tool may be held stationary while the second object is moved in contact with the cutting tool. In certain embodiments, both the cutting tool and the second object may be moved while in contact with each other. The movements used may be lateral or rotary. The cutting tool or a chuck connected to the cutting tool may rotate relative to the second object or the second object may rotate relative to the cutting tool. Examples of cutting tools include, but are not limited to, a drill bit, a saw blade, a milling tool, a lathe cutting tool, or the like.

“Workpiece” refers to any object or structure that is receiving one or more actions in relation to one or more stages of a procedure or operation. For example, when drilling a hole in a plate, the plate is the workpiece because the plate receives the drilling action. When machining an end of a pipe to form threads, the pipe and/or pipe end are the workpiece.

“Vise” refers to a machine that serves to hold an object such as a workpiece stationary while functions or steps are performed on the workpiece. Generally, a vise includes a pair of jaws of clamps that are pressed together with the workpiece between the jaws. In certain embodiments, one jaw of the pair is stationary while the other jaw is configured to slide or move towards and retract away from the stationary jaw. In other embodiments, both jaws may be coupled to a stationary platform, frame, or base and one or more drivers may drive both jaws toward each other or retract the jaws away from each other with the workpiece positioned between the jaws. A variety of drive mechanisms may be used to drive and/or retract one or more of the jaws towards and/or away from each other. For example, the drive mechanism may be mechanical and may include a leadscrew anchored to one jaw and configured to thread through a second jaw. In another example, a hydraulic or pneumatic ram may connect to one or the other or both jaws and may extend to move the jaws towards each other and may retract to separate the jaws.

“X-axis” refers to an axis that is horizontal to a base reference plane. “Y-axis” refers to an axis that is vertical to a base reference plane. “Z-axis” refers to an axis that is horizontal to a base reference plane and perpendicular to a Y-axis and an x-axis.

As used herein, a “plate” refers to a flat structure. In certain embodiments, a plate can be configured to support a load. In certain embodiments, a plate may comprise a generally planar structure. A plate can be a separate structure connected to, or integrated with, another structure. Alternatively, a plate can be connected to part of another structure. A plate can be two-dimensional or three-dimensional and can have a variety of geometric shapes and/or cross-sectional shapes, including, but not limited to a rectangle, a square, or other polygon, as well as a circle, an ellipse, an ovoid, or other circular or semi-circular shape. A plate can be made from a variety of materials including, metal, plastic, ceramic, wood, fiberglass, or the like. One plate may be distinguished from another based on where the plate is positioned within a structure, component, or apparatus. For example, an “upper plate” can include a plate positioned on, near, or integrated with, a structure such that the plate is at, or near, a top of the structure. Similarly, a “lower plate” can include a plate positioned on, near, or integrated with, a structure such that the plate is at, or near, a bottom of the structure.

“X-axis plate” refers to a plate that facilitates and enables positioning, orienting, moving, and/or repositioning of one or more cutting tools along an x-axis of a machining system or assembly. In certain embodiments, an x-axis plate may serve a function much like a jaw of a chuck.

“Machining” refers to a process in which a material (often metal) is cut to a desired final shape, size, or to include a particular shape or feature by a controlled material-removal process. The processes that have this common characteristic are collectively referred to as subtractive manufacturing. Machining may be a part of the manufacture of many products, whether metal, wood, plastic, ceramic, and/or composite material. The machining process includes processes such as turning, boring, drilling, milling, broaching, sawing, shaping, planning, reaming, and tapping. Certain machining tools may be capable of performing one or more of these machining processes, such machining tools may include, but are not limited to lathes, milling machines, drill presses, or the like and may use a sharp cutting tool to remove material to achieve a desired geometry, shapes, forms, and/or features. (Search “machining” on Wikipedia.com Aug. 2, 2022. Modified. Accessed Oct. 11, 2022.).

As used herein, “feature” refers to a distinctive attribute or aspect of something. (Search “feature” on google.com. Oxford Languages, 2021. Web. 20 Apr. 2021.) A feature may include one or more apparatuses, structures, objects, systems, sub-systems, devices, or the like. A feature may include a modifier that identifies a particular function or operation and/or a particular structure relating to the feature. Examples of such modifiers applied to a feature, include, but are not limited to, “attachment feature,” “bone attachment feature,” “securing feature,” “placement feature,” “protruding feature,” “engagement feature,” “disengagement feature,” “resection feature”, “guide feature”, “alignment feature”, “machining feature”, and the like.

“Machining feature” refers to any structure, shape, feature, or aspect formed in a workpiece through machining. Examples of a machining feature include, but are not limited to, a thread (internal or external), a bore, a hole, an opening, a groove or channel, a bevel, a chamfer, and the like.

“Chuck” refers to a specialized type of clamp used to hold an object with radial symmetry, such as a cylinder. In a drill tool or machining tool, a mill, or a transmission, a chuck may hold or secure a rotating cutting tool; in a lathe, a chuck may hold a rotating workpiece. A chuck may include jaws that hold a cutting tool or workpiece. The jaws (sometimes called dogs) may be arranged in a radially symmetrical pattern. Chucks on some lathes may include jaws that move independently, allowing them to hold irregularly shaped objects. (Search “chuck (engineering)” on Wikipedia.com Oct. 7, 2022. Modified. Accessed Oct. 11, 2022.).

As used herein, “actuator” refers to a component of a machine that is responsible for moving and/or controlling a component, structure, lever, mechanism, or system. (Search “actuator” on Wikipedia.com Nov. 15, 2021. CC-BY-SA 3.0 Modified. Accessed Dec. 28, 2021.)

“Jaw” refers to a structure, apparatus, assembly, and/or component configured to engage an object and restrict movement of the object. In certain embodiments, a jaw may restrict movement temporarily, for example during a stage of an operation or a procedure. Or, a jaw may restrict movement of the object permanently. Often, a jaw may include one or more teeth and may have a form or configuration that can resemble the jaw of a person or animal. In certain embodiments, a jaw may also be referred to as a holder, a grip, a pincer, a clamp, or the like.

“Insert” refers to an apparatus, instrument, structure, device, component, system, or assembly that is structured, organized, configured, designed, arranged, or engineered to couple or connect to one or more other components, parts, or devices. In certain embodiments, an insert is configured to be inserted or deployed onto another component or structure. In certain embodiments, an insert may also be referred to as a tool bit or tooth.

“Servo” or “servomechanism” refers to an automatic device that uses error-sensing negative feedback to correct the action of a mechanism. For displacement-controlled applications, a servo can include a built-in encoder or other position feedback mechanism to ensure the output is achieving the desired effect. The term correctly applies to systems where the feedback or error-correction signals help control mechanical position, speed, attitude or any other measurable variables. (Search “servomechanism” on Wikipedia.com Jul. 12, 2022. Modified. Accessed Oct. 11, 2022.).

“Threading” refers to a machining process that forms a set of one or more threads onto or within a workpiece. The threads formed can be external and on a surface of a workpiece or internal and within a hole, channel, or passage of the workpiece. Threading may form one or more helical threads and/or one or more conical threads. In certain embodiments, threading can form tapered threads or parallel threads along a length of the workpiece. Threads formed using threading may have a variety of profiles including metric, American national (unified), 60 degree stub, square, acme, stub acme, buttress, knuckle, whitworth, and the like. Threading may form unified coarse threads (UNC), unified coarse threads (UNF), 8-UN threads (8 thread), American Taper Pipe Thread or National Pipe Thread (NPT), American Taper Pipe Thread for dry seal without sealant compound or National Pipe Taper Fue (NPTF), or the like.

“Grooving” refers to a machining process that forms a groove or channel around an external surface of a cylindrical workpiece such as a pipe. The groove may have perpendicular walls and a flat bottom or one or more of the walls may angle at any angle between 0 and 180 between an external surface of the workpiece and a bottom of the groove.

“Beveling” refers to a machining process that forms an edge on a workpiece that is not perpendicular to one or more faces of the workpiece. A bevel shape may be referred to as a chamfer as well. (Search “bevel” on Wikipedia.com Aug. 18, 2022. Modified. Accessed Oct. 17, 2022.) Beveling may be used to form a new edge and the bevel may be identified by the shape of the edge in profile after is it formed. Examples, of bevel shapes include “J” bevel, “V” bevel, “V” bevel with counterbore, “J” bevel with counterbore, compound bevel, compound J bevel, and the like.

“Zero-return” of “home position” refers to a position for a Computer Numerical Control (CNC) machine. Specifically, the zero-return position is an initial starting position before the CNC performs any operations to implement a particular machining procedure. Said another way, the zero-return position is the position the moving parts of a CNC machine start in before initiating a machining program. A zero-return or home position can serve as a point of reference from which adjustments can be made along one or more axes. Generally, movement of a cutting tool or other part of a CNC machine is done in relation to the zero-return or home position and movement in one direction along an axis is measured in positive units (metric or imperial) and movement in an opposite direction along the same axis is measured in negative units. In certain embodiments, a zero-return position can include a location of a longitudinal axis for a workpiece.

“Leadscrew”, “power screw”, or “translation screw” refers to a cylindrical rod with at least one set of external threads on at least one end. The rod may be solid or hollow. The rod may include threads on both ends. The rod includes, or may be coupled to, a driver that rotates the rod about its longitudinal axis. Rotation of the rod converts rotary motion to linear motion of one or more linkages coupled to the rod by the at least one set of threads. A leadscrew is a screw used as a linkage in a machine, to translate turning motion into linear motion. Because of the large area of sliding contact between male and female members of the leadscrew and linkages that engage the at least one set of threads, screw threads of lead screws can have larger frictional energy losses compared to other linkages. Leadscrews can be used for intermittent use in low power actuator and positioner mechanisms. Leadscrews are commonly used in linear actuators, machine slides (such as in machine tools), vises, presses, and jacks. Leadscrews are a common component in electric linear actuators. Leadscrews are manufactured in the same way as other thread forms (they may be rolled, cut, or ground). (Search “leadscrew” on Wikipedia.com Jun. 3, 2022. Modified. Accessed Oct. 18, 2022.)

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

“Ovality” refers to the deviation of a geometric shape from being a perfect circle, where the shape takes on an oval or elliptical form. It is a measure of how much an object, such as a cylindrical or circular structure, deviates from a true circular shape.

The term “ovality” is often used in the context of engineering, manufacturing, and quality control to describe the variation in shape of circular objects. Ovality is typically expressed as a ratio or percentage that represents the difference between the major and minor axes of the shape. Mathematically, ovality (O) can be defined as: (Maximum Diameter−Minimum Diameter) divided by Maximum Diameter. The Maximum Diameter is the major axis of the shape and the Minimum Diameter is the minor axis of the shape. Ovality values range from 0 (perfect circle) to 1 (maximum deviation, forming a straight line). A higher ovality value indicates a more pronounced deviation from circularity. (© ChatGPT Aug. 3.5 Version, Modified, accessed chat.openai.com/chat Dec. 8, 2023).

As used herein, “end” refers to a part or structure of an area or span that lies at the boundary or edge. An end can also refer to a point that marks the extent of something and/or a point where something ceases to exist. An end can also refer to an extreme or last part lengthwise of a structure or surface. (search “end” on Merriam-Webster.com. Merriam-Webster, 2021. Web. 4 Aug. 2021. Modified.)

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

In spite of certain advances in manufacturing technology, many products include one or more machining steps as part of the fabrication process. Conventional manufacturing processes include machines that configure or shape or form different features on, in, around, or about one or more parts of a workpiece. For example, lathes may rotate a workpiece at high speed while a cutting tool is brought in contact with the workpiece to shape the workpiece and/or form a feature in, on, or around the workpiece by removing material from the workpiece. Lathes may be suitable for small workpieces of diameters of a few inches or lengths of a few feet. However, with larger workpieces rotating the workpiece to machine the workpiece can become impractical.

A mill provides an alternative to a lathe. Mills rotate a cutting tool either about its own axis or about one or more axes of the workpiece to remove material for the machining operation. With a mill, the workpiece is stationary and the cutting tool is moved.

Machining using mills can be used for finishing the fabrication of, or repairing, features on the ends of pipe or solid cylindrical workpieces. Typically, mills rely on the workpiece being symmetrical about a longitudinal axis of the workpiece. In mills that rely on a stationary workpiece and move or rotate a cutting tool relative to the workpiece, if the workpiece is not symmetrical about a longitudinal axis the feature formed in the workpiece may not meet required specifications. For various applications of features formed on the ends of pipe or solid cylindrical workpieces precision and accuracy in the dimensions of the features and/or aspects of the features can be very important. For certain applications, accuracy and precision may be required down to tenths, hundredths, or even thousandths of millimeters or inches. If such accuracy and precision requirements are not satisfied, the feature or aspect on the pipe or solid cylindrical workpiece may be compromised and the desired function and/or suitability not met.

One factor that can influence accuracy and precision of pipe or solid cylindrical workpiece is how accurately and/or precisely the pipe or solid cylindrical workpiece meets expected dimensions and/or configurations. For example, a pipe has an inner diameter and an outer diameter. For various reasons, the inner diameter may not be the same for each pair of opposite points around an inner wall of a cross section of the pipe. Similarly, the outer diameter may not be the same for each pair of opposite points around an outer surface of a cross section of the pipe. Said another way, an end of a pipe or solid workpiece may not be truly round, truly circular or may have some degree or percentage of ovality or non-circularity. In certain fields, the specifications for inner or outer threads, or a groove, or a bevel on the end of a pipe may require minimal ovality in the pipe end. In other words, the use case for the threads, grooves, or bevels may require that these features be cut into a pipe end that has a cross section that is as close to perfectly round as possible.

The present disclosure provides a milling machine that minimizes, mitigates, compensates for, or removes, ovality and forms threads, grooves, and bevels in a workpiece such as a pipe end or solid cylinder. Furthermore, the present disclosure forms threads, grooves, and bevels in a workpiece that are uniform and consistent around the longitudinal axis of the workpiece despite inherent ovality. Furthermore, the present disclosure forms threads, grooves, and bevels and or a combination of these, with minimal, and in certain cases, no time needed for changeover from one cutting tool to another.

FIG. 1 is a side view illustrating one embodiment of a system 100 for threading, grooving, and beveling according to one embodiment. The system 100 includes a mill 110 and a vise 120.

The mill 110 turns a cutting tool 130 in relation to a workpiece 140 to form features in, or on, the workpiece by removing material from the workpiece. In certain embodiments, the cutting tool 130 is coaxial with a longitudinal axis of the mill 110 and the mill 110 may rotate that cutting tool 130 about its longitudinal axis. Alternatively, or in addition, the cutting tool 130 rotates the cutting tool 130 about a longitudinal axis of the workpiece 140.

In one embodiment, the cutting tool 130 is coupled to the mill 110 by a chuck 150 that is coupled to a rod, shaft, or spindle 160 that couples to the mill 110. In the illustrated embodiment, the spindle 160 is coupled to a first driver 170 within a housing 180. The housing 180 holds the first driver 170 which is coupled to the chuck 150.

The mill 110 may include a plurality of drivers. In one embodiment, one or more of the drivers may be drive motors. One or more of the drivers may be an electric motor and/or may be a variable speed electric motor. In one embodiment, one or more of the drivers may be, or may include a servo or servomechanism. In certain embodiments, one or more of the drivers may be a manual driver operated by an operator.

The first driver 170 rotates the spindle 160 which rotates the chuck 150 about a longitudinal axis of the spindle 160. The cutting tool 130 may be connected to the chuck 150 and in contact with the workpiece 140 such that rotating the chuck 150 causes the cutting tool 130 to remove material from the workpiece 140. Alternatively, or in addition, the cutting tool 130 may be near the workpiece 140 and the mill 110 may move the cutting tool 130 to a position in which the cutting tool 130 contacts the workpiece 140. As the cutting tool 130 contacts the workpiece 140, the cutting tool 130 removes material from the workpiece 140. The cutting tool 130 may contact an outer surface of the workpiece 140 and thereby form a machining feature on the outer surface, such as, for example a thread, a groove, a bevel, or the like. Alternatively, or in addition, the cutting tool 130 may contact an inner surface of the workpiece 140 and thereby form a machining feature on the inner surface, such as, for example a thread, a groove, a bevel, or the like.

In one embodiment, the first driver 170 may be configured to rotate the chuck 150 and cutting tool 130 at revolutions per minute of between about 1 and about 300 rpms. Contact between the cutting tool 130 and the workpiece 140 generates heat due to friction. Advantageously, the rotation of the cutting tool 130 can dissipate a certain amount of the heat generated by the cutting action.

In one embodiment, the spindle 160 and driver 170 are within a housing 180 that is within, on, mounted to, or coupled to, a frame 190. The frame 190 serves to support and hold the mill 110 in a stationary position on a ground, ground surface, floor, or other planar structure 200. In certain embodiments, the frame 190 may include feet. The feet may be adjustable so that the feet can be adjusted to level the frame 190. The frame 190 serves as a platform for forming machining features.

FIG. 1 illustrates a three-dimensional axis 210. The three-dimensional axis 210 includes a Y-axis, an X-axis, and a Z-axis. The Y-axis runs vertical and perpendicular to the ground 200 which serves as a base reference plane. The X-axis runs horizontal to, and parallel to, the ground 200, or a base of the frame 190. The Z-axis runs horizontal to, and parallel to, the ground 200, or a base of the frame 190 and perpendicular to the X-axis. In certain embodiments, the X-axis and Z-axis are used to control a position of the cutting tool 130 relative to a workpiece center point of origin 220. The point of origin 220 is a point at an end of the workpiece 140 closest to the mill 110 that is on a longitudinal axis 230 of the workpiece 140 and expected to be equidistant from each point on a surface (external or internal) of the workpiece 140 that circumscribes the point of origin 220. In certain embodiments, the three-dimensional axis 210 is aligned with and shares the same position as the point of origin 220 (e.g., is coincident with the point of origin 220).

In one embodiment, the chuck 150 includes a center point 240 and an x-axis plate 250. The chuck 150 may also include a vertical Y-axis that is parallel to the Y-axis of the three-dimensional axis 210 and a horizontal X-axis that is parallel to the X-axis of the three-dimensional axis 210. The vertical Y-axis may extend vertically from the center point 240 and the horizontal X-axis may extend horizontally from the center point 240. Once the mill 110 is setup for operation, the longitudinal axis of the spindle 160 is, or should be, coaxial with the Z-axis of the three-dimensional axis 210 and coaxial with a longitudinal axis of the workpiece 140 that is coaxial with a Z-axis of the workpiece 140.

The x-axis plate 250 may be coupled to the cutting tool 130 and may be configured to move laterally relative to the center point 240 and can be coupled to one or more cutting tools 130. Said another way, the x-axis plate 250 may be coupled to the cutting tool 130 and may be configured to move radially relative to the center point 240 (away from, or toward, the center point 240 in any direction about the center point 240 in a single plane). The x-axis plate 250 is also coupled to the chuck 150.

The mill 110 also includes a second driver 260 coupled to the x-axis plate 250. The second driver 260 is configured to move the x-axis plate 250 laterally relative to the center point 240. Moving the x-axis plate 250 also moves the cutting tool 130 along the X-axis. In this manner, the cutting tool 130 can be moved towards, or away from, the longitudinal axis 230 of the workpiece 140 to form different features on, or in, the workpiece 140.

In certain embodiments, the mill 110 also includes a third driver 270 configured to move the chuck 150 along the Z-axis of the workpiece 140 and/or the Z-axis of the three-dimensional axis 210. The third driver 270 moves the chuck 150 and coupled cutting tool 130 along a length of the workpiece 140. Movement of the cutting tool 130 by the third driver 270 enables the cutting tool 130 to cut a thread in the external surface or internal surface of a workpiece 140, such as a pipe. In the illustrated embodiment, the workpiece 140 is a pipe. Those of skill in the art will appreciate that the workpiece 140 can be a variety of objects including but not limited to a pipe, a pipe end, an elbow pipe, elbow pipe adapter, a bar, a solid rod, a cylinder, or the like. In certain embodiments, the workpiece 140 has a cylindrical shape.

In one embodiment, the first driver 170, the second driver 260, and the third driver 270 each include a drive motor. The drive motor may be a servo motor or a stepper motor. In certain embodiments, the mill 110 may include a first servo coupled to the programable controller 280. The first servo may include the first driver 170. Alternatively, or in addition, the mill 110 may include a second servo coupled to the programable controller 280. The second servo may include the second driver 260. alternatively, or in addition, the mill 110 may include a third servo coupled to the programable controller 280. The third servo may include the third driver 270.

In one embodiment, the mill 110 includes a programmable controller 280. In one embodiment, the programmable controller 280 is within the frame 190. Alternatively, or in addition, the programmable controller 280 may be separate from the frame 190 and/or housing 180. The programmable controller 280 is in electronic communication with one or more of the first driver 170, the second driver 260, and/or the third driver 270.

The programmable controller 280 may control operation of the first driver 170 by communicating a first control signal to the first driver 170. The first control signal may initiate rotation of the chuck 150, stop rotation, increase the number of revolutions for minute, and/or decrease the number of revolutions for minute. The programmable controller 280 may control operation of the second driver 260 by communicating a second control signal to the second driver 260. The second control signal may initiate movement of the x-axis plate 250 laterally relative to the center point 240. In one embodiment, the second control signal may increase an x-position of the x-axis plate 250 relative to the center point 240 or decrease an x-position of the x-axis plate 250 relative to the center point 240. The programmable controller 280 may control operation of the third driver 270 by communicating a third control signal to the third driver 270. The third control signal may initiate movement of the chuck 150 closer to the workpiece 140 and/or further away from the workpiece 140.

In one embodiment, drivers of the system 100 may be, or may include servos that are coupled to the programmable controller 280. The first driver 170 may comprise a servo coupled to the programmable controller 280. The second driver 260 may comprise a servo coupled to the programmable controller 280. The third driver 270 may comprise a servo coupled to the programmable controller 280. Alternatively, or in addition, the vise 120 may include a driver for operating the vise. This driver may also be a servo coupled to the programmable controller 280. Each of the servos coupled to the programmable controller 280 can be electronically controlled and can be activated, deactivated, caused to move, and/or caused to retract in order to complete one or more machining operations in relation to a workpiece 140.

Advantageously, the programmable controller 280 can be configured to operate one or more predefined programs (such as software for example) in order to add one or more features to a workpiece 140. In one embodiment, the programmable controller 280 is configured to store and/or to read “G” and “M” codes. “G” codes control the movement of a machine and “M” codes control various machine functions such as starting and stopping certain actions or programs. (See www.americanmicroinc.com search G code and M code). In certain embodiments, “G” and “M” codes are one example of a suitable format for software that the programmable controller 280 may read, interpret, and/or execute to form one or more machining features on or in a workpiece 140.

In one embodiment, the programmable controller 280 may comprise a CNC controller available from FANUC of Oshino, Yamanashi, Japan. The programs for the programmable controller 280 may be entered manually via a user interface (hardware, software, graphical user interface GUI, or a combination of these), entered using an I/O peripheral such as a portable storage device such as a USB thumb drive, and/or provided over a computer network using a network connection and/or a wireless connection.

In one embodiment, the mill 110 operates using a fixed and known point of reference. This point of reference can be the center point 240 or the point of origin 220. Whether the center point 240 or the point of origin 220 is used as the point of reference does not materially impact the operation of the mill 110 since coordinates, distances, angles, and/or movements can be coordinated from either the center point 240 or the point of origin 220 as a point of reference. The point of reference serves as the zero-return or home position for the mill 110. The programmable controller 280 executes and implements programs based on this zero-return for each of the axes (X, Y, and Z).

In the illustrated embodiment, movement of the housing 180, chuck 150, and/or cutting tool 130 toward the workpiece 140 along the Z-axis (e.g., by way of the third driver 270) can be represented by a negative value in the z-direction, along the Z-axis. Movement of the housing 180, chuck 150, and/or cutting tool 130 away from the workpiece 140 can be represented by a positive value in the z-direction, along the Z-axis. The first driver 170, spindle 160 and/or chuck 150 cooperate to move the cutting tool 130 clockwise or counterclockwise about the Z-axis, which should be coaxial with the longitudinal axis 230 of the workpiece 140. Movement of the x-axis plate 250 by way of the second driver 260 along the X-axis towards a right side of the chuck 150 when viewed facing a front surface of the chuck 150 can be represented by a positive value in the x-direction, along the X-axis. Movement of the x-axis plate 250 by way of the second driver 260 along the X-axis towards a left side of the chuck 150 when viewed facing a front surface of the chuck 150 can be represented by a negative value in the x-direction, along the X-axis.

The second driver 260 moving the x-axis plate 250 causes the cutting tool 130 connected to the x-axis plate 250 to move along the X-axis. Movement of the cutting tool 130 along the X-axis alone can change how close or far away the cutting tool 130 is to the longitudinal axis 230 which can impact how the cutting tool 130 cuts the workpiece 140. Movement of the cutting tool 130 along the X-axis together with movement of the cutting tool 130 along the Z-axis and/or rotation of the cutting tool 130 about the Z-axis can enable the cutting tool 130 to form a variety of features in a workpiece 140 including, but not limited to: one or more threads (referred to as threading), one or more grooves (referred to as grooving), and/or one or more bevels (referred to as beveling).

The system 100 includes a vise 120 or other tool for holding the workpiece 140 and keeping the workpiece 140 stationary for the machining operations. The vise 120 is configured to engage and secure the workpiece 140 in a stationary position with respect to the mill 110. The workpiece 140 includes a Z-axis coaxial with a longitudinal axis 230 of the workpiece 140.

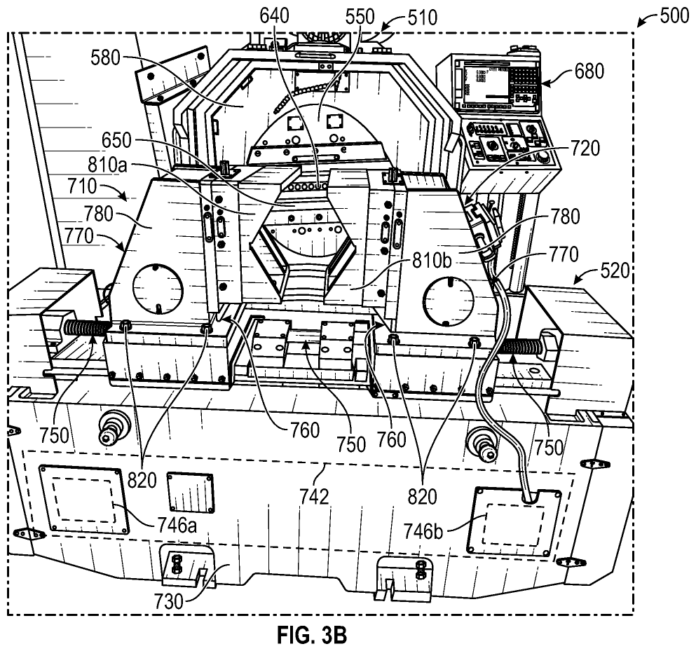

The vise 120 includes a first jaw 310 and a second jaw 320 (not shown in FIG. 1, similar to second jaw 720 shown in FIG. 3A). The jaws serve to engage the workpiece 140 and retain the workpiece 140 in a fixed and stationary position as the mill 110 performs machining procedures on the workpiece 140. The first jaw 310 is configured to engage the workpiece 140 from a first side of the workpiece 140. The second jaw 320 is configured to engage the workpiece 140 from a second side of the workpiece 140. The first side of the workpiece 140 is opposite the second side of the workpiece 140.

The vise 120 can include one or more jaw drivers, also referred to as jaw positioners, that can move the first jaw 310 towards the second jaw 320, the second jaw 320 towards the first jaw 310, or move both or each jaw 310,320 towards each other simultaneously. In one embodiment, the vise 120 and/or jaw drivers can be controlled by an operator using buttons, switches, a touchscreen, or other operator interface manually. Alternatively, or in addition, vise 120 and/or jaw drivers can be controlled by the programmable controller 280 and/or by the programmable controller 280 together with one or more manual controls operated by the operator.

The jaw drivers and/or jaw positioner positions the jaws to engage and/or retain the workpiece 140. Advantageously, the jaw positioner can translate the jaws laterally/horizontally (along the X-axis), vertically (along the Y-axis), both horizontally and vertically, and/or any combination in between. In one embodiment, the jaw positioner can include a gross adjustment apparatus and a fine adjustment apparatus. These apparatuses translate the jaws in a direction relative to the mill 110 in preparation for a machining operation. The gross adjustment apparatus translates one or more jaws in a particular direction in larger steps or adjustments, for example many feet or inches with each step. The fine adjustment apparatus translates one or more jaws in a particular direction in smaller steps or adjustments, for example a few inches, millimeters, tenths of millimeters, or thousandths of millimeter with each step. The range for gross adjustments may range from about half a foot to about four feet. The range for fine adjustments may range from about 10 thousandths of a millimeter to ten centimeters.

In one embodiment, the gross adjustment apparatus and/or fine adjustment apparatus support analog gross adjustments and analog fine adjustments, respectively. For example, mechanical apparatus such as threads, screws, gears, and the like can be used to make gross adjustments over a large distance and complete the adjustment at almost any position along the gross range of adjustments.

In certain embodiments, the fine adjustment apparatus can include a vertical adjustment apparatus and a lateral adjustment apparatus. The vertical adjustment apparatus enables fine adjustment along the Y-axis. The lateral adjustment apparatus enables fine adjustment along the X-axis.

In one embodiment, the gross adjustment apparatus enables lateral adjustment and not vertical adjustment. In such an embodiment, the lateral adjustment apparatus cooperates with the gross adjustment apparatus to enable fine adjustment along the X-axis together with the gross adjustment along the X-axis enabled by the gross adjustment apparatus.

In the illustrated embodiment, the jaw positioner can provide lateral movement and/or adjustment of the first jaw 310 and/or second jaw 320. In addition, the vise 120 can include a lateral adjustment apparatus 340 that can provide further adjustment (e.g., fine adjustment) of one or both or either of the first jaw 310 and the second jaw 320. In certain embodiments, the vise 120 may include a single lateral adjustment apparatus 340 that can adjust both the first jaw 310 and the second jaw 320 together. In other embodiments, the vise 120 can include a separate lateral adjustment apparatus 340 for the first jaw 310 and a separate lateral adjustment apparatus 340 for the second jaw 320. In certain embodiments, one or more jaw positioners can provide gross adjustment of the first jaw 310 and/or second jaw 320 and one or more lateral adjustment apparatuses 340 can provide fine adjustment of the first jaw 310 and/or second jaw 320.

In one embodiment, the jaw positioner is configured to mitigate, eliminate, remove, control, counteract, and/or overcome ovality at an end of a workpiece 140. For example, in one embodiment, the jaw positioner can include one or more lateral adjustment apparatuses specifically designed to counteract ovality. In particular, the lateral adjustment apparatuses may be configured to counteract ovality when a major axis for a cross section of the end of the workpiece 140 is parallel to and/or approximately parallel to the X-axis.

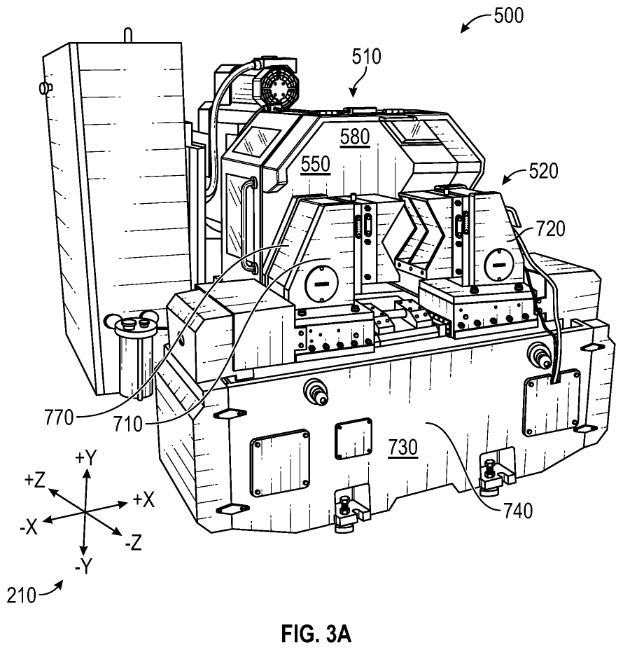

FIG. 2 is a side view illustrating another embodiment of a system 400 for threading, grooving, and beveling, according to one embodiment. The system 400 may have many structures, features, and functions, operations, and/or configurations similar or identical to those of the system 100 described in relation to FIG. 1, like parts are identified with the same reference numerals.

In system 400, the frame 190 sits on the ground 200 as in system 100 however, the frame 190 is coupled to the vise 120. In system 100, the vise 120 and mill 110 are separate. The frame 190 may be coupled to, or connected to, a base 330 of the vise 120 by fasteners and/or the frame 190 may form part of the base 330. In one embodiment, the third driver 270 may function to move the housing 180 laterally along the Z-axis. In one embodiment, the third driver 270 may include a leadscrew 410 that engages an extension 420 of the frame 190. In this manner, the frame 190 is coupled to the vise 120, the housing 180, and the third driver 270. To facilitate movement of the housing 180 along the Z-axis, in certain embodiments, the housing 180 may include wheels 430 that roll along the frame 190 as the third driver 270 moves the housing 180 along the Z-axis. Those of skill in the art will appreciate that a track or gears or rails or other structures can be used in place of wheels 430.

FIG. 2 illustrates that as part of setup an operator may use the vise 120 to position an end of the workpiece 140 such that the point of origin 220 of the workpiece 140 is aligned with the center point 240 on the chuck 150. Ideally, the point of origin 220 is on the same axis as the longitudinal axis 230 of the workpiece 140. As explained herein, the point of origin 220 may not be exactly aligned with the longitudinal axis 230 if the end of the workpiece 140 has ovality. FIG. 2 illustrates that the vise 120 engages an end of the workpiece 140. The workpiece 140 may extend from the vise 120 for a few feet, yards, or miles. In certain embodiments, at least a portion of the workpiece 140 closest to the end that is secured in the vise 120 has been supported or raised vertically such that the longitudinal axis 230 aligns with the center point 240. Alternatively, or in addition, the vise 120 can include a gross vertical adjustment apparatus and/or a fine vertical adjustment apparatus that can facilitate alignment of the longitudinal axis 230 with the center point 240.

In addition, the vise 120 includes a jaw positioner comprising at least a lateral adjustment apparatus configured to counteract ovality at the end of the workpiece 140. In the illustrated embodiment, the frame 190 is coupled to the vise 120, to the housing 180, and to a third driver 270. Advantageously, the frame 190 is coupled to the vise 120, to the housing 180, and to a third driver 270 such that operation of the third driver 270 causes the housing 180 to move along the Z-axis either closer to the workpiece 140 or further away from the workpiece 140.

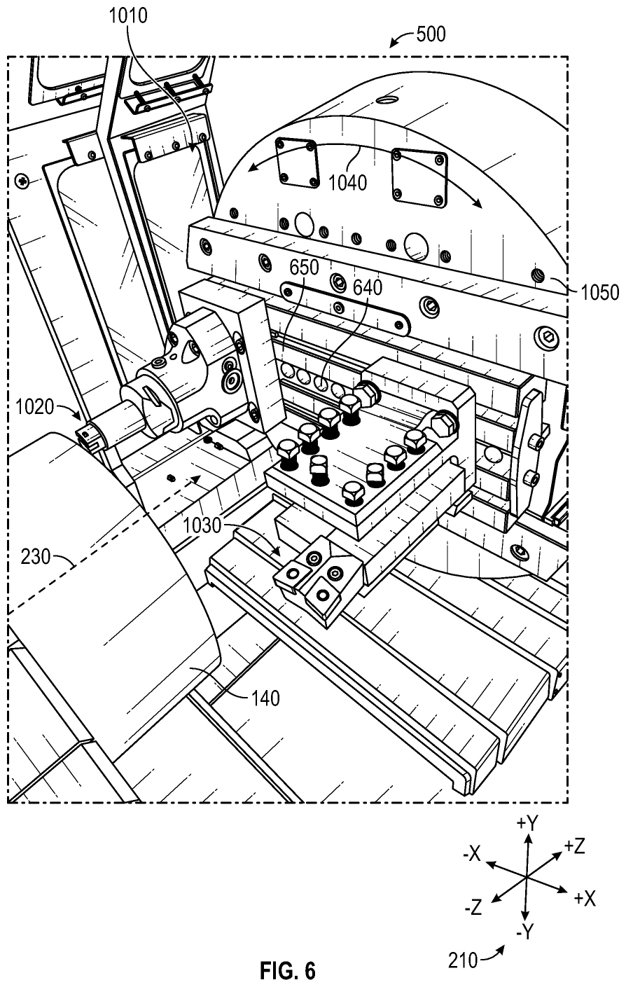

FIGS. 3A-3C are perspective views of one embodiment of a system 500 for threading, grooving, and beveling, according to one embodiment. The system 500 may have many structures, features, and functions, operations, and/or configurations similar or identical to those of the system 100 described in relation to FIG. 1, like parts are identified with the same reference numerals. Accordingly, the system 500 includes a mill 510, a vise 520, a cutting tool 530 (not shown in FIGS. 3A-3C, the same or similar to cutting tool 1020 shown in FIG. 6), a chuck 550, a housing 580, a center point 640 (See FIG. 3B), an x-axis plate 650, a programmable controller 680, a first jaw 710, a second jaw 720 and a base 730. Each of these components may perform a similar function or provide a similar feature to a corresponding, and/or similarly numbered, component described in relation to FIGS. 1-2. For example, the mill 510 corresponds to the mill 110, the vise 120 to the vise 520, the center point 240 to the center point 640, etc.

FIG. 3A illustrates the three-dimensional axis 210, the system 500 with the mill 510, vise 520. The mill 510 includes the housing 580 and chuck 550. The vise 520 includes the base 730, first jaw 710, and second jaw 720. A workpiece 140 and cutting tool 130 are not shown or visible in FIG. 3A. The first jaw 710 and second jaw 720 may be coupled to a jaw positioner 740.

In the illustrated embodiment, the jaw positioner 740 includes a servo that includes an electric motor and one or more mechanical drivers and/or couplings that engage the first jaw 710 and/or the second jaw 720. The jaw positioner 740 can be in electronic communication with a programmable controller 680 (See FIG. 3B). The programmable controller 680 can control the jaw positioner 740 to open and close the jaws. The jaw positioner 740 serves as a jaw driver for one or more of the jaws 710,720.

FIG. 3B illustrates a closer view of the system 500 in FIG. 3A. In the illustrated embodiment, the jaw positioner 740 includes a gross adjustment apparatus 742. The gross adjustment apparatus 742 is configured to move at least one of the first jaw 710 and the second jaw 720 laterally to engage and retain the workpiece 140 in a stationary position. In the illustrated embodiment, the gross adjustment apparatus 742 may be configured to translate both the first jaw 710 and the second jaw 720 together. For example, a drive or driver of the gross adjustment apparatus 742 may be coupled to both the first jaw 710 and the second jaw 720 such that activation of the drive or driver (e.g., activation of the gross adjustment apparatus 742) translates both the first jaw 710 and the second jaw 720 together. In certain embodiments, the first jaw 710 and the second jaw 720 may be coupled to the gross adjustment apparatus 742 such that activation of the gross adjustment apparatus 742 translates both the first jaw 710 and the second jaw 720 simultaneously or substantially simultaneously.

In the illustrated embodiment, the gross adjustment apparatus 742 includes a first motor 746a configured to translate the first jaw 710 and a second motor 746a configured to translate the second jaw 720. In one embodiment, the motors 746 are electric motors, servo motors, and/or servos mounted within the base 730 of the vise 520. Of course, the motor 746 can be pneumatic, jet, internal combustion, or the like.

FIG. 3C illustrates a close-up view of one example mechanical connection between a gross adjustment apparatus 742 and a jaw. In particular, FIG. 3C illustrates a mechanical connection between the gross adjustment apparatus 742 and the first jaw 710. Those of skill in the art will appreciate that a mechanical connection between the gross adjustment apparatus 742 and the second jaw 720 may be similar and/or substantially the same.

The jaw positioner 740 may include one or more mechanical gears 748 and/or other mechanical linkages that couple the servos (e.g., motor 746) to the first jaw 710 and/or second jaw 720. In the illustrated embodiment, a single gross adjustment apparatus 742 is coupled to both the first jaw 710 and the second jaw 720 by gears and a single leadscrew 750. The leadscrew 750 may be coupled to the base 730 by two or more linkages and may include opposite direction threads near each end that coupled to a linkage for the first jaw 710 and second jaw 720.

One side of the leadscrew 750 may include left-handed threads and the other side of the leadscrew 750 may include right-handed threads. As the gross adjustment apparatus 742 rotates the leadscrew 750 in a first direction, the jaws 710, 720 may move linearly along the leadscrew 750 towards each other simultaneously. As the gross adjustment apparatus 742 rotates the leadscrew 750 in a second direction, the jaws 710, 720 may move linearly along the leadscrew 750 away from each other simultaneously. Advantageously, the gross adjustment apparatus 742 enables gross or coarse engagement of, and/or positioning of a workpiece 140 in relation to the chuck 550. In the illustrated embodiment, the middle of the leadscrew 750 may be aligned with the center point 640 of the chuck 550.

Each jaw 710, 720 can include a face side 760, a back side 770, a front side 780, and a rear side 790. A face side 760 may be a side of the jaw that faces another jaw when deployed on the vise 520. The back side 770 may be a side of the jaw opposite the face side 760. A rear side 790 may be a side of the jaw facing a mill 510 when the vise 520 and mill 510 are deployed together in a system 500. A front side 780 may be a side of the jaw opposite the rear side 790. The front side 780 may face a workpiece 140.

The jaws 710,720 can be aligned with each other and can face each other when in an open configuration and when in a closed configuration. In an open configuration, the jaws 710,720 may be furthest away from each other and may not contact or otherwise engage a workpiece 140. In a closed configuration, the jaws 710,720 may be closest to each other and may contact and/or engage a workpiece 140 between each of the jaws 710,720.

Each jaw may include an adapter 810 coupled to the face side 760 of the jaw. The adapter 810 can be configured to engage the workpiece 140 and be configured, or configurable, to account for the type, size, shape, and orientation of the workpiece 140. In the illustrated embodiment, the workpiece 140 is a pipe and the adapter has a wide sideways “V” shaped profile to facilitate engagement with the workpiece 140.

The jaws 710, 720 are coupled to a base 330 by one or more anchor fasteners 820. The base 330 serves to hold the jaws level and in place during machining operations. In certain embodiments, the base 330 may include feet or anchors that secure the vise 120 to the ground or floor where machining is being performed. Similarly, the frame 190 may include feet or anchors to keep the mill 110 level and stationary during machining operations.

FIG. 3D illustrates a closer perspective side view of the system 500 in FIG. 3A. FIG. 3D illustrates a leadscrew 750, a first jaw 710, and a back side 770, front side 780, rear side 790 of the first jaw 710. FIG. 3D also illustrates a chuck 550, a housing 580, and an x-axis plate 650.

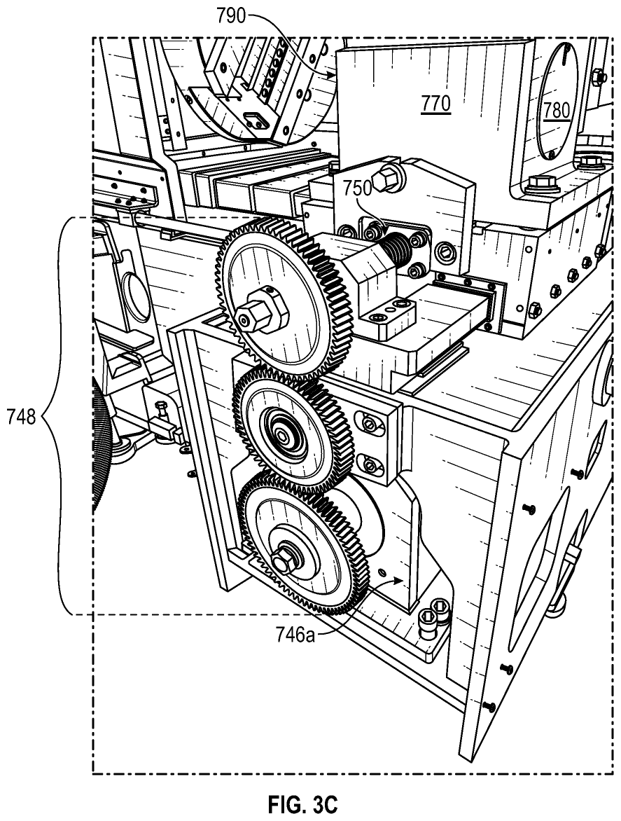

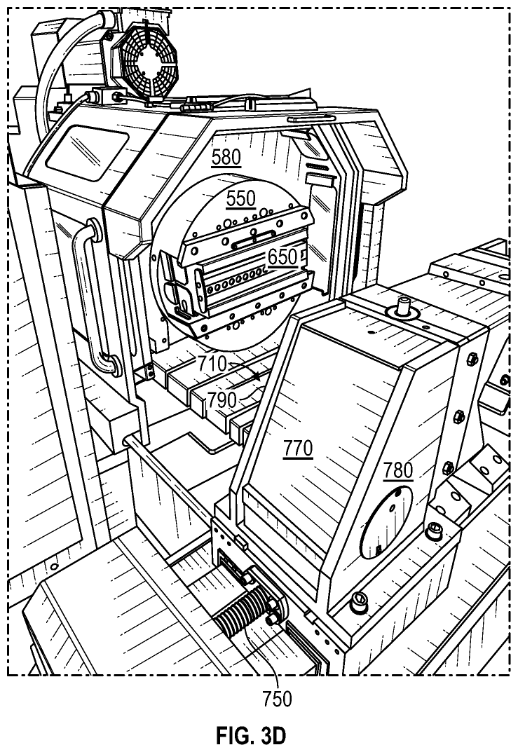

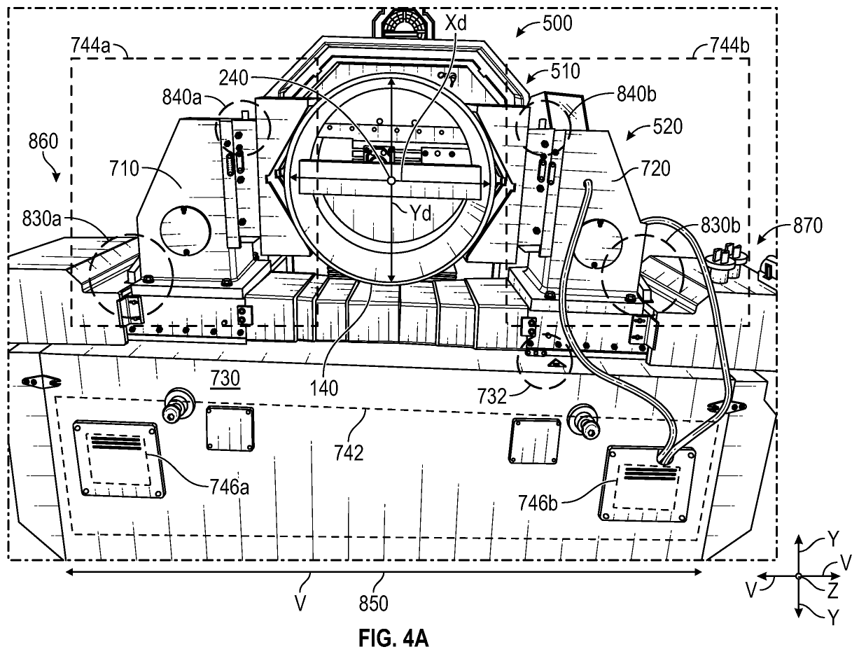

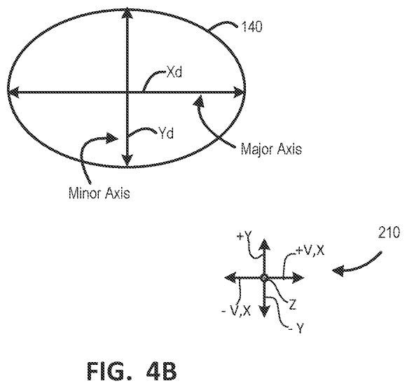

FIG. 4A is a front view illustrating one embodiment of a system 500 for threading, grooving, and beveling, according to one embodiment. The system 500 includes a workpiece 140 positioned between the first jaw 710 and second jaw 720. Advantageously, the system 500 is configured to machine features on the workpiece 140 with high precision. To achieve the desired precision, the point of origin 220 should be aligned with the center point 640 of the chuck 550. By calibrating, positioning, and aligning the mill 510 with the vise 520 and the workpiece 140 within the vise 520 the precision machining features can be formed.

Unfortunately, aligning the point of origin 220 and the center point 640 may not be enough to enable the system 500 to create one or more desired machining features. This is because the mill 510 is configured to form very precise and accurate machining features, therefore, the size and shape and configuration of the workpiece 140 needs to be taken into account.

A workpiece 140, particularly at its end where the machining feature is to be formed, may not be completely round in the section or about the section of the workpiece 140 where the machining feature (e.g., threads for threading, grooves for grooving, or a beveled edge for beveling) is to be formed. Said another way the ovality for the section, or about, the section (e.g., the end) of the workpiece 140 where the machining feature is to be formed may be greater than zero. Due to the precision of the mill 510 if the end of the workpiece 140 is not completely round, has an amount of ovality above a certain threshold (e.g., >=8%), machining of the machining features may result in machining features that do not meet the needs of the user. For example, a workpiece 140 with ovality can result in external threads that are too shallow on one side and too deep on another. These differences can result in leaks or failures in couplings that rely on the machining feature.

FIG. 4B illustrates a cross section view of an example workpiece 140 having ovality. The ovality illustrated may be exaggerated to illustrate the concept. Ovality is a measure of how round a cross section of an object is. When a cross section of an object has ovality at least one diameter of the cross section is greater than another. Ovality can be calculated by measuring a maximum diameter for the cross section of the object and a minimum diameter for the cross section of the object. When a closed circular shape is close to but not completely round the shape is an ellipse shape. The maximum diameter is the major axis of an ellipse shape, and the minimum diameter is the minor axis of an ellipse shape. The major axis is the longest diameter of the cross section that passes through the center of the shape. The minor axis is the shortest diameter of the cross section that passes through the center of the shape.

Ovality is a ratio of the major axis length to the minor axis length. Ovality can be computed by the formula: (major axis length−minor axis length) divided by average diameter. This results in a value between 0 and 1. Alternatively, or in addition, the result can be multiplied by 100 to provide a percentage. Ovality can be calculated using the outer diameter or the inner diameter. But, the measurements for the computation are all either for outer diameters or for inner diameters.

Because of various factors, including manufacturing imperfections, construction tolerances, and the like, a certain level of ovality can be acceptable. For example, the ASME (American Society of Mechanical Engineers) has defined a 5% ovality as an acceptable maximum ovality threshold and may accept cylindrical workpieces that are between about 5% ovality and about 8% ovality. However, the acceptable percentage of ovality can depend on the user and the intended use for the cylindrical workpieces. Thus, ovality can range significantly depending on the circumstances.

In the illustrated example, the workpiece 140 has a horizontal diameter Xd (in this example, the horizontal diameter is an inner diameter but either an inner diameter or an outer diameter can be used) and a vertical diameter Yd (in this example, the vertical diameter is an inner diameter but either an inner diameter or an outer diameter can be used). Where the Xd=Yd, the ovality is zero. With an ovality of zero, desired precision machining features can be formed. In the illustrated cross section, Xd is the major axis and Yd is the minor axis for the ellipse of the cross section. The three-dimensional axis 210 illustrates that in this example, the major axis Xd is parallel to the X axis and minor major axis Yd is parallel to the Y axis. FIG. 4B illustrates a three-dimensional axis 210 that shows how the cross section of the workpiece 140 relates to the axes of the mill 510 and vise 520.

In this example, suppose the Xd measures to be 24 inches and the Yd measures to be 26 inches and the average diameter (inner diameter in this example) measures to be 25 inches. In this example the ovality is (26−24)/25=0.08. Multiplying the result by 100 for a percentage equals 8%. In certain embodiments, this may be acceptable for using the mill 510 and vise 520 to form a machining feature. In other embodiments, this ovality may be too high. The planned machining feature and/or use for the workpiece 140 with the machining feature may require a lower ovality.

In this example, Xd≠Yd and the workpiece 140 has an ovality greater than zero or greater than a threshold. Rather than being a perfectly round shape, a cross section of the workpiece 140 in the area to be machined is an oval shape and includes a major axis and at least one minor axis. In certain embodiments, for certain machining features a certain amount of ovality may be acceptable and/or tolerable. For other machining features that same ovality may be unacceptable.

Advantageously, the solutions presented in the present disclosure includes one or more of a jaw positioner 740 that can counteract and/or adjust to account for ovality at an end of a workpiece 140 that is greater than the ovality threshold for a particular machining feature.

Referring now to FIG. 4A, an example Xd (major axis) and Yd (minor axis) are illustrated with the example workpiece 140 positioned between the first jaw 710 and the second jaw 720. The vise 520 includes a jaw positioner 740 that includes a gross adjustment apparatus 742 and a fine adjustment apparatus 744.

The gross adjustment apparatus 742 can be substantially the same as and/or similar to the gross adjustment apparatus 742 described in relation to the vise 520 of FIG. 3B.

In certain embodiments, the fine adjustment apparatus 744 can include a lateral adjustment apparatus 830 and a vertical adjustment apparatus 840. A lateral adjustment apparatus 830 and/or a vertical adjustment apparatus 840 can be used to counteract ovality, account for, and/or adjust for and/or compensate for imperfections in the roundness or ovality at an end of the workpiece.

In certain embodiments, if an operator is aware or determines that an end of the workpiece 140 has ovality, the operator may rotate the workpiece 140 when the workpiece 140 is positioned between the jaws such that the major axis Xd is parallel with the X-axis of the vise 520. In this manner, the operator can use the lateral adjustment apparatus 830 to counteract the ovality as part of the setup for the machining operation.

Advantageously, the lateral adjustment apparatus 830 enables an operator to increase or decrease a force applied to the workpiece 140 to counteract ovality. The vise 520 engages the workpiece 140 such that the workpiece 140 does not move when the cutting tool 130 comes in contact with the workpiece 140. Similarly, an operator may use the vertical adjustment apparatus 840 to increase a force on the workpiece 140 in a vertical and/or a non-horizontal direction in order to counter ovality of the workpiece 140. In yet another example, an operator may use both one or more lateral adjustment apparatuses 830 and one or more vertical adjustment apparatuses 840 to counteract ovality of the workpiece 140. In certain embodiments, an operator can increase this force applied by the fine adjustment apparatus 744 to one or more sides of the workpiece 140 bends the workpiece 140 at that section such that a major axis length is decreased. Alternatively, or in addition, an operator can decrease the force applied by the fine adjustment apparatus 744 to one or more sides of the workpiece 140 such that the workpiece 140 bends (relaxes) at that section such that a minor axis length is increased.

Those of skill in the art will appreciate that the system 500 may include one lateral adjustment apparatus 830 that affects both jaws 710, 720 or just one jaw and/or may include one vertical adjustment apparatus 840 that affects both jaws 710, 720 or just one jaw. Similarly, the system 500 may include a first lateral adjustment apparatus 830a for a first jaw 710 and a second lateral adjustment apparatus 830b for a second jaw 720.

In one embodiment, the system 500 may include a first vertical adjustment apparatus 840a for adjusting the first jaw 710 along the Y-axis and a second vertical adjustment apparatus 840b for adjusting the second jaw 720 along the Y-axis. In this manner, the system 500 may include a vertical adjustment apparatus is configured to adjust the first jaw 710 independent of the second jaw 720. Alternatively, or in addition, the fine adjustment apparatus 744 may include a lateral adjustment apparatus 830 configured to adjust both the first jaw 710 along the Y-axis and the second jaw 720 along the Y-axis together.

Where the Yd is greater than the Xd, an operator may operate one or both of the vertical adjustment apparatuses 840a,b which can increase or decrease pressure on the workpiece 140 in the Y-axis direction to compensate for the greater Yd. In this manner, an operator can compensate for ovality to get a more round workpiece 140 for machining the machining features. In certain cases, the Yd may be greater than the Xd because of pressure being applied to the workpiece 140 by the jaws 710,720. In this case, an operator may adjust one or both of the lateral adjustment apparatuses 830a,b (and/or the gross adjustment apparatus 742) to relieve the pressure and remove the ovality by permitting the workpiece 140 to relax.

Similarly, where the Xd is greater than the Yd, an operator may operate one or both of the lateral adjustment apparatuses 830a,b which can increase or decrease pressure on the workpiece 140 in the X direction to compensate for the greater Xd. In this manner, an operator can compensate for ovality to get a more round workpiece 140 for machining the machining features. In certain cases, the Xd may be greater than the Yd because of pressure being applied to the workpiece 140 by the jaws 710,720 and/or adapters 810 of the jaws. In this case, an operator may adjust one or both of the vertical adjustment apparatuses 840a,b to relieve the pressure and remove the ovality.

For example, suppose Yd is greater than Xd because the jaws 710,720 are applying too much pressure on the workpiece 140 and that the workpiece 140 would be round if the pressure is relieved. To address the ovality, an operator may operate one of, or both of, the lateral adjustment apparatuses 830a,b to provide a fine lateral adjustment to the pressure applied to the workpiece 140. Alternatively, or in addition, an operator may operate the gross adjustment apparatus 742 to provide a gross lateral adjustment to the pressure applied to the workpiece 140. In this manner, the ovality can be removed and more precise machining features can be formed by the system 500.

It should be noted that both the gross adjustment apparatus 742 and the lateral adjustment apparatus 830 adjust the first jaw 710 and second jaw 720 along the horizontal axis, the X-axis. If both the first jaw 710 and the second jaw 720 can translate along the X-axis, providing both a gross adjustment apparatus 742 and a lateral adjustment apparatus 830 can be a challenge. However, the present disclosure has overcome this challenge by way of the embodiments provided herein.

In certain embodiments, it is desirable to operate the system 500 “in the field” meaning in an area outside of a machine shop. Instead of bringing the workpiece 140 to the system 500, system 500 can be brought to a job site and may machine features onto, or in, the workpiece 140 at the job site. Advantageously, such portable on-site operation is less expensive and less complicated if the systems of the system 500 use a minimal set of electronic motors and/or servos or servo motors and no or limited pneumatic and/or hydraulic systems.

Accordingly, in one embodiment, the lateral adjustment apparatus 830 and/or the vertical adjustment apparatus 840 using only mechanical systems and not pneumatic and/or hydraulic systems. In this manner, the complexity and costs of deploying and maintaining the system 500 are minimized. Similarly, the system 500 is more portable than conventional systems.

FIGS. 1 and 2 illustrate portable systems 100, 400 that includes a mill 110 and a vise 120. In the system 100, the vise 120 may be anchored to the ground 200 using one or more anchors. In the system 400, the vise 120 may not need to be anchored to the ground 200 because the vise 120 is coupled to the housing 180 by the frame 190. In one embodiment, the housing 180 and vise 120 are coupled to the frame 190. With the mill 110 and vise 120 coupled to the frame 190, the system 400 forms a single portable unit, this portable unit may be transported on a truck or boat or barge or airplane to a job site.

Referring to FIG. 4A, in one embodiment, the gross adjustment apparatus 742 provides sufficient force on a free end of the workpiece 140 that the gross adjustment apparatus 742 can position the workpiece 140 such that a longitudinal axis (e.g., longitudinal axis 230 in FIG. 1) of the workpiece 140 is moved to be coaxial with the Z-axis of the mill 510.

The lateral adjustment apparatus 830 and vertical adjustment apparatus 840 enable fine adjustments of the shape and/or position of the workpiece 140 such that the point of origin 220 aligns with the center point 240 and/or unacceptable ovality in the end of the workpiece 140 is counteracted. The system 500 can form precision machining features in a workpiece 140 using CNC technologies, servos, and/or the programmable controller 680. The programmable controller 680 can manage the first driver 170, second driver 260, third driver 270, and the jaw positioner 740.

In one embodiment, each of these drivers is a servo and/or servo motor and the servos include a zero-return position. The zero-return position for the first driver 170 may be not rotating (e.g., no rotational movement) about the Z-axis, the zero-return position for the second driver 260 may be the greatest positive position along the X-axis, and the zero-return position for the third driver 270 may be the greatest positive position along the Z-axis (e.g., furthest away from the workpiece 140). These zero-return positions place the parts of the system 500 in a position to facilitate insertion or removal of a new workpiece 140, changing of a cutting tool, maintenance of the system 500, checks for ovality, and the like.

For desired operation, the programmable controller 680 is provided a zero-return position for the vise 520 and/or the workpiece 140. In the present disclosure, the zero-return position is managed in relation to a V-axis 850. The vise 520 includes a first end 860 and a second end 870. A V-axis is a reference access for the vise 520. The V-axis 850 extends through the first jaw 710 and the second jaw 720 and runs parallel to the X-axis of the system 500. In certain embodiments, a programmable controller 680 may rely on and/or may reference a V-axis 850 before, during, or after setup and/or execution of a set of software or computer instructions (e.g., machine executable code) to form a machining feature and/or perform another function in relation to the workpiece 140.

In the illustrated embodiment, the V-axis 850 includes a zero-return position that defines when the vise 520 is in the zero-return position. In one embodiment, the zero-return position for the vise 520 is when the jaws 710,720 are in a fully open position. When the jaws 710,720 are in a fully open position, the V-axis=0. In certain embodiments, the system 500 may include a position indicator 732. “Position indicator” refers to any apparatus, structure, device, system, and/or component organized, configured, designed, engineered, and/or arranged to serve as an indicator of a position for one or more things, objects, structures, apparatuses, systems, or the like. Examples of a position indicator include, but are not limited to, a crosshair, cross hairs, a pin, a wire, a fastener, a hole, an opening, a post, a prong, a needle, an arrow, a marking, or the like. In certain embodiments, an indicator may communicate a position of one structure or component or system in relation to another.

The position indicator 732 may be installed between the base 730 translatable part of one or more of the first jaw 710 and/or second jaw 720. In FIG. 4A, the position indicator 732 is installed between the second jaw 720 and the base 730. In the illustrated embodiment, when a marking on the second jaw 720 aligns with a marking on the base 730, the V-axis is in a zero-return position. When the marking on the second jaw 720 is closer to the workpiece 140 than the marking on the base 730, the V-axis is in a positive V-axis position.

In certain embodiments, the programmable controller 680 may only permit setting or changing of parameters for the system 500 when the V-axis=0. Said another way, the component or device being controlled in connection with the V-axis needs to be a zero-return position before the programmable controller 680 will accept a new set of instructions or revisions to a set of instructions.

FIG. 4C illustrates a control panel 880 or user interface for the programmable controller 680. The control panel 880 indicates that the V-axis=0, this means that the jaws 710,720 of the vise 520 are in the fully open position. Note the X setting or X-axis setting of +9.3450, the Y setting or Y-axis setting of −2.2261, and the V setting or X-axis setting of 0.0000.

FIG. 4D illustrates a control panel 880 in which the X-axis, Z-axis, and V-axis are each at 0. In such an embodiment, the Z-axis value for the system 500 may not be at a zero-return position (for example where a Z-axis zero-return position is the greatest positive movement position (movement toward the workpiece 140) along that axis) while the V-axis may be at a zero-return position. In certain embodiments, a zero-return position for an X-axis may be alignment with a longitudinal axis of a workpiece along the X-axis then positive movement along the X-axis may be in one direction along the X-axis and negative movement along the X-axis may be in an opposite direction along the X-axis.

Referring now to FIGS. 1-4D, the present disclosure includes a number of embodiments. In one embodiment, the present disclosure provides an apparatus for cutting or machining a workpiece 140. In one embodiment, the apparatus includes a programmable controller 680, a housing 580, a third driver 270, and a vise 520.

The programmable controller 680 is configured to form a machining feature on a workpiece 140. In one embodiment, this may mean that the programmable controller 680 follows, implements, and/or executes a series of “G” and “M” software executable codes configured for the machining feature. Of course, other kinds of software and/or firmware may be executed by the programmable controller 680 to machine a machining feature.

As described herein, the housing 580 includes a chuck 550, a first driver 170, and a second driver 260. The chuck 550 may be similar to, or substantially the same as, chuck 150. The chuck 550 includes a center point 240 and an x-axis plate 250. The chuck 150 may also include a vertical Y-axis that is parallel to a Y-axis of the three-dimensional axis 210 and a horizontal X-axis that is parallel to an X-axis of the three-dimensional axis 210. The vertical Y-axis may extend vertically from the center point 240 and the horizontal X-axis may extend horizontally from the center point 240.

The chuck 550 serves as a platform for the x-axis plate 250 which is coupled to a cutting tool 130. The chuck 550 can facilitate changeover because the chuck 550 can include a variety of different couplings for interfacing with one or more cutting tools 130. The x-axis plate 250 may be coupled to the cutting tool 130 and may be configured to move laterally relative to the center point 240 and can be coupled to one or more cutting tools 130. The cutting tool 130 is configured to form one or more machining features on or in the workpiece 140 (specifically, an end of workpiece 140) as the cutting tool 130 contacts the workpiece 140 and the cutting tool 130 moves relative to the workpiece 140. As explained, the cutting tool 130 may rotate about the longitudinal axis 230 of the workpiece 140, may move along the Z-axis closer to or further from the workpiece 140, and/or may rotate about a longitudinal axis of the cutting tool 130 and move toward the workpiece 140 to bore or drill into the workpiece 140.

The first driver 170 is coupled to the chuck 550 and configured to rotate the chuck 550 about a Z-axis of the chuck 550 in response to a first control signal from the programmable controller 680. The Z-axis extends perpendicular to the X-axis and perpendicular to the Y-axis.

The second driver 260 is coupled to the X-axis plate 250. The second driver 260 moves the x-axis plate 250 laterally relative to the center point 240 in response to a second control signal from the programmable controller 680.

The third driver 270 is configured to move the chuck 150 along the Z-axis of the workpiece 140 and/or the Z-axis of the three-dimensional axis 210. The third driver 270 moves the chuck 550 along the Z-axis in response to a third control signal from the programmable controller 680.

The vise 520 includes a first jaw 710, a second jaw 720, and a jaw positioner 740. The first jaw 710 engages a workpiece 140 from a first side of the workpiece 140. In one embodiment, the first jaw 710 is configured to engage a workpiece 140 on a side having a rounded, curved, and/or circular surface. The second jaw 720 engages a workpiece 140 from a second side of the workpiece 140. In one embodiment, the second side is on the same side as the first side. In another embodiment, the second side is opposite the first side. In one embodiment, the second jaw 720 is configured to engage a workpiece 140 on a side having a rounded, curved, and/or circular surface.

In one embodiment, the jaw positioner 740 is configured to move one or more of the jaws (e.g., first jaw 710 and/or second jaw 720) laterally to engage and retain the workpiece 140 in a stationary position. In certain embodiments, the jaw positioner 740 includes a gross adjustment apparatus 742 and a fine adjustment apparatus 744. The fine adjustment apparatus 744 may be configured to counteract ovality at an end of the workpiece 140.

In one embodiment, the fine adjustment apparatus 744 includes a lateral adjustment apparatus 830 and a vertical adjustment apparatus 840. One or the other or both of the lateral adjustment apparatus 830 and/or the vertical adjustment apparatus 840 are configured to counteract ovality at an end of the workpiece 140. The vertical adjustment apparatus 840 may adjust a grip of the vise 520 on the workpiece 140 along the Y-axis. A grip is a tight hold. The lateral adjustment apparatus 830 may adjust a grip of the vise 520 on the workpiece 140 along the X-axis. It should be noted that while the lateral adjustment apparatus 830 and/or vertical adjustment apparatus 840 may adjust a grip on the workpiece 140, the respective grip may not be adjusted to the point that contact of the cutting tool 130 with the workpiece 140 causes the workpiece 140 to change position and/or orientation.

In another embodiment, the jaw positioner 740 may include a lateral adjustment apparatus 830 configured to counteract ovality at an end of the workpiece 140. The lateral adjustment apparatus 830 and/or fine adjustment apparatus 744 may include a first lateral adjustment apparatus 830a for fine adjustment of a first jaw 710 and a second lateral adjustment apparatus 830b for fine adjustment of a second jaw 720.

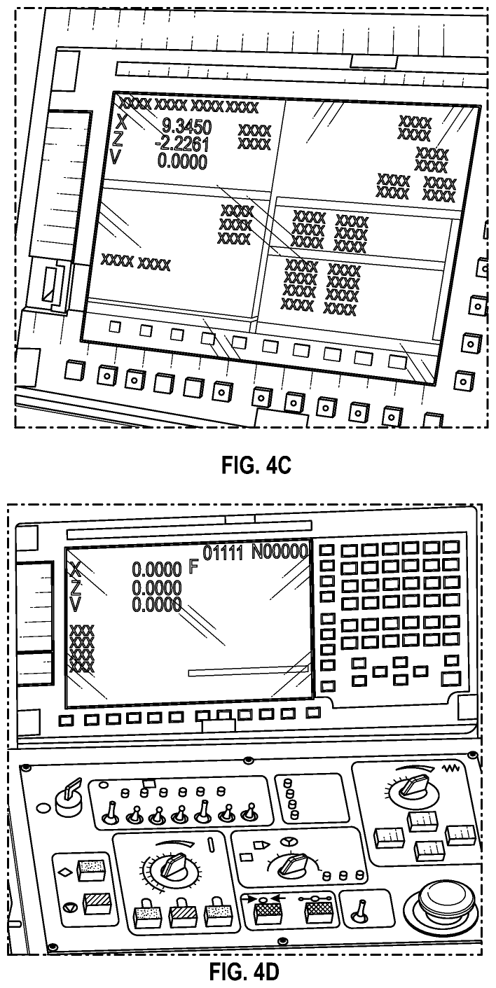

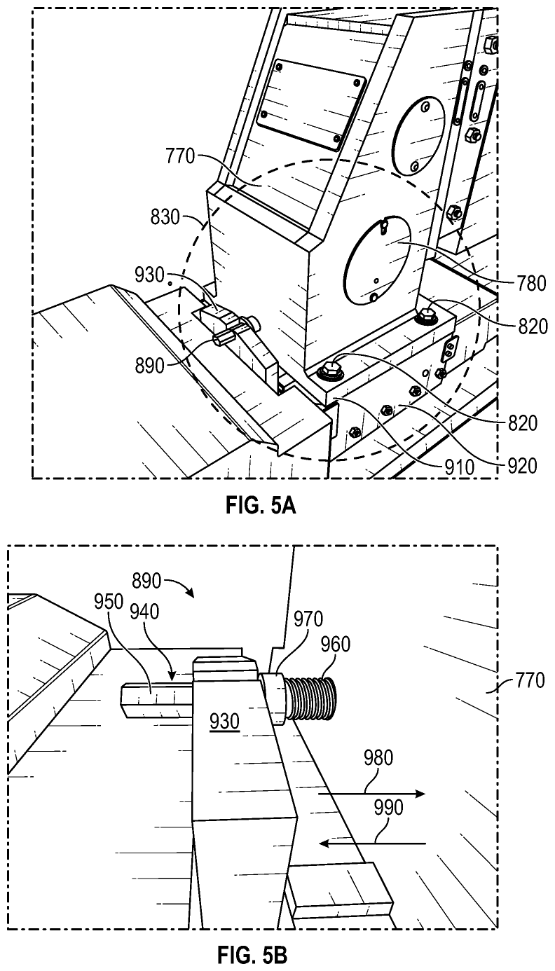

FIG. 5A is a close-up perspective view of one example of a lateral adjustment apparatus 830. In one embodiment, the lateral adjustment apparatus 830 includes a linear actuator 890, a jaw baseplate 910, a slidable jaw member 920, and a plurality of fasteners, referred to herein as anchor fasteners 820.

The linear actuator 890 enables lateral linear movement of a jaw, such as first jaw 710 or second jaw 720. In the illustrated embodiment, the linear actuator 890 is a mechanical simple machine, a screw. The linear actuator 890 cooperates with a coupling (not shown) that engages a jaw and a stationary member 930 to move the jaw. Advantageously, the linear actuator 890 is configured to move the jaw either toward an opposite jaw or away from an opposite jaw.

The linear actuator 890 is configured to extend and to retract a jaw horizontally along a horizontal X-axis, also referred to as a V-axis of the vise 120, 520. In certain embodiments, these adjustments are incremental adjustments or fine adjustments rather than gross adjustments.

The jaw baseplate 910 sits at a base of the jaw and enables the jaw to be coupled to the slidable jaw member 920 by a plurality of anchor fasteners 820. The anchor fasteners 820 are configured to secure a jaw baseplate 910 to the slidable jaw member 920. A slidable jaw member 920 is a structure that permits movement of the jaw baseplate 910 and first jaw 710 relative to the slidable jaw member 920. In certain embodiments, in order for slidable jaw member 920 to permit movement of the jaw baseplate 910, the anchor fasteners 820 may need to be loosened.

In one embodiment, the anchor fasteners 820 may pass through slots (not shown) in the slidable jaw member 920 and engage cage nuts or captive nuts (not shown) on an opposite side of the slots. The size and length of the slots allow for the anchor fasteners 820 to move laterally within slots to enable fine adjustment of a position of a jaw.

In one embodiment, the slidable jaw member 920 is coupled to the jaw positioner 740 of the vise 520, for example by way of a linkage to the leadscrew 750. Rotating the leadscrew 750 causes the slidable jaw member 920 to move toward or away from an opposite jaw. Moving (e.g., by way of gross adjustment apparatus 742) the slidable jaw member 920 laterally enables a coarse or gross lateral positioning or adjustment of a jaw. The plurality of anchor fasteners 820, when engaged, or tight, maintain the position of the jaw in relation to the slidable jaw member 920. In this manner, movement of the slidable jaw member 920 moves the jaw as well. In one embodiment, the anchor fasteners 820 are configured to secure a jaw baseplate 910 to a slidable jaw member 920 which is translatable by a jaw positioner 740.

In the illustrated embodiment, the linear actuator 890, jaw baseplate 910, slidable jaw member 920, and anchor fasteners 820 cooperate with a mechanical coupling to the gross adjustment apparatus 742 such that the vise 520 provides both gross lateral adjustment features as well as fine adjustment features along the horizontal X-axis (e.g., V-axis 850).

FIG. 5A illustrates a lateral adjustment apparatus 830 for a first jaw 710 that can be moved independent of the second jaw 720. Those of skill in the art will appreciate that the second jaw 720 can also be coupled to a lateral adjustment apparatus 830 that is the same as, or similar to, lateral adjustment apparatus 830 described in relation to FIG. 5A. A lateral adjustment apparatus 830 coupled to the second jaw 720 can be used to make fine lateral (aka X-axis, V-axis) adjustments of the second jaw 720 independent of the first jaw 710, just as described in relation to the first jaw 710 as illustrated in FIG. 5A.

FIG. 5B is a close-up perspective view of one example of a lateral adjustment apparatus 830. The linear actuator 890 may include a leadscrew 940 or rod having a driver end 950, a threaded end 960 opposite the driver end 950, and a collar 970 between the driver end 950 and the threaded end 960. In certain embodiments, the linear actuator 890 is a leadscrew 940.

The driver end 950 serves to enable an operator to rotate the leadscrew 940 to make a fine lateral adjustment of a jaw. In one embodiment, the driver end 950 has a hexagonal cross section sized and configured to engage a hand tool (not shown) such as a box end, open end wrench, socket, or the like. The threaded end 960 includes one or more sets of external helical threads that may engage with a linkage coupled to the jaw. The collar 970 abuts the stationary member 930 and keeps the leadscrew 940 in place as rotational movement of the leadscrew 940 converts to lateral movement of the jaw coupled to the leadscrew 940. Lateral movement of the leadscrew 940 away from the jaw is impeded by the stationary member 930 which then causes the rotational movement of the leadscrew 940 to be converted into lateral movement of the jaw towards an opposite jaw.

The stationary member 930 maintains a position of a linear actuator 890 along the horizontal X-axis as the linear actuator 890 operates. In the illustrated embodiment, the stationary member 930 retains the leadscrew 940 such that the leadscrew 940 does not move laterally as the leadscrew 940 is rotated. Instead, the rotational movement of the leadscrew 940 is converted to lateral movement of the first jaw 710.

In one embodiment, as an operator rotates the driver end 950 in one direction (e.g., clockwise) the rotational motion is transferred along the leadscrew 940 and to the first jaw 710 by way of a coupling between the leadscrew 940 and the first jaw 710. In this manner, the leadscrew 940 moves or translates the first jaw 710 along the horizontal X-axis towards the center point 240. The lateral movement of the first jaw 710 increases a lateral force of the first jaw 710 on the workpiece 140. In certain embodiments, the increased force shortens a length of a major axis that defines ovality at an end of the workpiece 140. In one embodiment, an operator may rotate the driver end 950 in the one direction while the first jaw 710 engages the workpiece 140. Alternatively, or in addition, an operator may disengage the first jaw 710 from the workpiece 140 and then rotate the driver end 950 in the one direction. After adjusting the lateral adjustment apparatus 830, the operator may then reengage the first jaw 710 and the workpiece 140.

In one embodiment, as an operator rotates the driver end 950 in another direction (e.g., counterclockwise) the rotational motion is transferred along the leadscrew 940 and to the first jaw 710 by way of a coupling between the leadscrew 940 and the first jaw 710. Threads of the leadscrew 940 rotate in the another direction.

In this manner, the leadscrew 940 moves or translates the first jaw 710 along the horizontal X-axis away from the center point 240. The lateral movement of the first jaw 710 decreases a lateral force of the first jaw 710 on the workpiece 140. In certain embodiments, the decreased force increases a length of a minor axis that defines ovality at an end of the workpiece 140. In one embodiment, an operator may rotate the driver end 950 in the another direction while the first jaw 710 engages the workpiece 140. Alternatively, or in addition, an operator may disengage the first jaw 710 from the workpiece 140 and then rotate the driver end 950 in the another direction. After adjusting the lateral adjustment apparatus 830, the operator may then reengage the first jaw 710 and the workpiece 140.

Referring now to FIGS. 5A and 5B, an operator may operate the lateral adjustment apparatus 830 to provide a fine adjustment to a position of a point of origin 220 for the workpiece 140, increase pressure on one side of a workpiece 140 to compensate for ovality, and/or decrease pressure on one side of a workpiece 140 to compensate for ovality. To make the adjustment, an operator may first determine that the point of origin 220 is not aligned with the center point 240 and/or determine that the workpiece 140 includes ovality that needs to be counteracted and/or compensated for.

After this determination is made, an operator may determine whether to operate a lateral adjustment apparatus 830 for a first jaw 710, a lateral adjustment apparatus 830 for a second jaw 720, or a lateral adjustment apparatus 830 for both a first jaw 710 and a second jaw 720. The operator then selects a jaw to be adjusted. Suppose for example, that the operator chooses the first jaw 710. Next, in one embodiment, an operator loosens the anchor fasteners 820 which enables the jaw to move relative to the slidable jaw member 920. Advantageously, the anchor fasteners 820 may not be completely removed and may still engage cage nuts or captive nuts (not shown) of the slidable jaw member 920.

Next, an operator couples a tool, such as a wrench hand tool to the driver end 950 and proceeds to rotate the leadscrew 940 about its longitudinal axis. Rotating the leadscrew 940 in a first direction, such as clockwise, may drive the jaw away from the stationary member 930 and toward an opposite jaw, in a second direction 980 (see arrow). Rotating the leadscrew 940 in a third direction, such as counterclockwise, may draw the jaw towards the stationary member 930 and away from an opposite jaw, in a fourth direction 990 (see arrow). The operator may rotate the leadscrew 940 a partial revolution and/or one or more full revolutions until a desired precision positioning of the jaw is accomplished. In the illustrated embodiment, operation of the lateral adjustment apparatus 830 for a first jaw 710, a second jaw 720, or for both may be done manually by an operator. In another embodiment, operation of the lateral adjustment apparatus 830 for a first jaw 710, a second jaw 720, or for both may be done using motors and/or other drivers which may be operated by an operator and/or an electronic controller such as a computing device.

Advantageously, the fine adjustment manually by an operator can ensure that the machining operation is highly accurate and precise. Thus, machining features of very high precision can be accomplished. In addition, manual adjustment by an operator allows for forming machining features based on the experience and know-how of an operator who can account for factors that may be unavailable to an automated or computer-controlled adjustment (e.g., ambient temperature, workpiece temperature, workpiece material quality, workpiece material composition, or the like).

Advantageously, once a desired precision positioning of the workpiece 140 by way of positioning one or more of the jaw2, 710, 720 is accomplished, the threaded end 960 may be configured to hold the jaw in position as an operator tightens the anchor fasteners 820 to secure the jaw in place. Alternatively, or in addition, an operator may cooperate with another user such that one holds the leadscrew 940 to keep the leadscrew 940 from reversing direction and the other may tighten the anchor fasteners 820.

After fine positioning of a jaw, an operator may check for alignment between the point of origin 220 and center point 240 and/or for ovality of the workpiece 140. If the alignment and ovality is within an acceptable set of specifications, the operator may proceed with a machining operation. If the alignment and ovality is outside an acceptable set of specifications, the operator may repeat the process described to make further precise adjustments to horizontal positioning of one or more jaws and/or pressure being applied to the workpiece 140 by jaws of the vise 520.

FIG. 6 is a perspective view illustrating a cutting face 1010 with tooling of a system for threading, grooving, and beveling, according to one embodiment. The cutting face 1010 is generally the area of a mill where the cutting operations are performed. In the illustrated embodiment, FIG. 6 illustrates a chuck 550, an x-axis plate 650, a workpiece 140, a first cutting tool 1020, and a second cutting tool 1030.

In the mill 510, the workpiece 140 remains stationary while the cutting tools move relative to the workpiece 140. In the illustrated embodiment, the chuck 550 is perpendicular to a longitudinal axis 230 of the workpiece 140. The cutting tools abrade the workpiece 140 to remove material in desired locations and in desired amounts.

In one embodiment, the chuck 550 can be rotated clockwise or counterclockwise (see arrow 1040). For example, if an external right-handed thread is to be machined onto an end of the workpiece 140 the chuck 550 can rotate counterclockwise. The programmable controller 680 instructs the first driver 170 to rotate the chuck 550. The programmable controller 680 can instruct the third driver 270 to move the chuck 550 toward the workpiece 140. As one of the cutting tools 530 is brought into contact with an external surface of the workpiece 140 the machining feature (e.g., threads) is formed. Depending on the kind of machining feature being formed in, or on, the workpiece 140, the programmable controller 680 may also instruct the second driver 260 to move the cutting tool 530 along the X-axis, for example to form a tapered external thread. In this manner, one or more machining features can be formed on, or in, the workpiece 140.

In one example, the workpiece 140 is steel pipe. Due to high forces needed to cut the workpiece 140, the cutting tools (e.g., first cutting tool 1020 or second cutting tool 1030) are securely connected to the x-axis plate 650 and/or chuck 550. Advantageously, the cutting tools are removable such that different machining features can be formed. Consequently, the cutting tools are coupled to the x-axis plate 650 using a plurality of fasteners such as set screws that secure a cutting tool to the x-axis plate 650.

The process of mounting, positioning, orienting and securing a cutting tool to the x-axis plate 650 is referred to as a changeover. The changeover process can take time and thus cost money that could be saved if changeover time is reduced or eliminated. Typically, a single cutting tool is mounted on the x-axis plate 650 for a machining operation. The machining operation is completed and then a changeover stage is completed to change the cutting tool for a subsequent machining operation.

Advantageously, the present disclosure enables performing two or more machining operations without a changeover between each machining operation. In one embodiment, because the programmable controller 680 can move the x-axis plate 650, the programmable controller 680 can operate a machining program to form a first machine feature using a first cutting tool 1020 and subsequently adjust the position of the x-axis plate 650 along the X-axis to form a second machine feature using a second cutting tool 1030. In one embodiment, the x-axis plate 650 is coupled to two or more cutting tools and the programmable controller 680 is configured to direct one of the cutting tools to cut into the workpiece 140 for a first stage of a cutting operation and to direct another one of the cutting tools to cut into the workpiece 140 for a second stage of the cutting operation.

The first machine feature and second machine feature may be formed in a single program or in multiple programs. Advantageously, both the first cutting tool 1020 and the cutting tool 1030 can be mounted and secured to the x-axis plate 650 during a single changeover stage. No changeover stage is needed to move from using the first cutting tool 1020 to using the second cutting tool 1030. In one example, the first cutting tool 1020 may be used to form internal threads on a pipe workpiece 140 and the second cutting tool 1030 may be used to form external threads on the pipe workpiece 140.

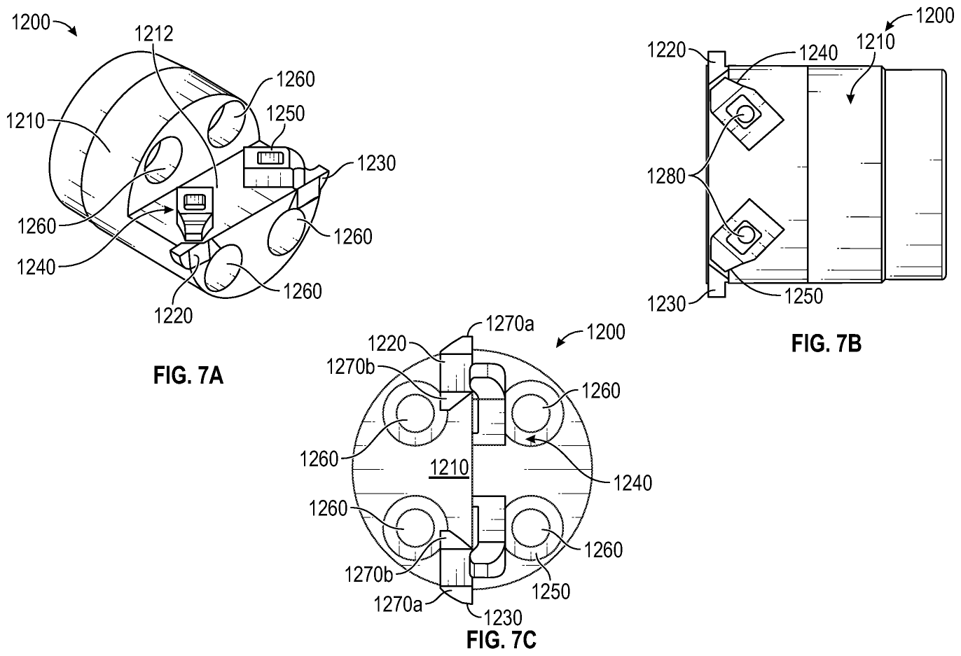

FIG. 7A-7C is a perspective view, top view, and end view respectively of a cutting tool 1200, according to one embodiment. The cutting tool 1200 includes a body 1210, a first insert 1220, and a second insert 1230. The first insert 1220 can be coupled to the body 1210 by a first fastener 1240. The second insert 1230 can be coupled to the body 1210 by a second fastener 1250.

The body 1210 supports the first insert 1220 and second insert 1230 and is configured to be coupled to an x-axis plate 650. Alternatively, or in addition, the body 1210 can include one or more holes 1260 or ports 1260. The one or more holes 1260 may serve to dissipate heat as the cutting tool 1200 is used. Alternatively, or in addition, the one or more holes 1260 may be used to supply a lubricant or coolant to the first insert 1220 and/or second insert 1230 during use. In one embodiment, the body 1210 includes a seat for each insert. The seat may be shaped and sized to accept a single insert and one or more walls of the seat may facilitate retaining the insert in the seat during a machining operation. Alternatively, or in addition, the body 1210 may include a planar surface 1212 upon which the fasteners (e.g., first fastener 1240 and/or second fastener 1250) are coupled.

In the illustrated embodiment, the seats and corresponding inserts are positioned opposite each other. Those of skill in the art will appreciate that the seats can be positioned at other locations on an end of the body 1210. These opposite inserts can be used to form two different machining features using a single cutting tool 1200. For example, first insert 1220 can be used to form a machining feature at an inner diameter of the workpiece and second insert 1230 can be used to form a machining feature at an outer diameter of the workpiece.

The first insert 1220 and/or second insert 1230 serve as a cutting blade to remove material from a workpiece 140 during a machining operation. The inserts 1220, 1230 can include one or more teeth 1270a,b that extend from one side or end of the insert. The teeth 1270 may extend from the insert and come to a point. The teeth 1270 engage with the workpiece 140 to form a machining feature.

The fasteners, such as first fastener 1240 and/or second fastener 1250, serve to hold the inserts in place and couple the inserts to the body 1210. In certain embodiments, the fasteners can include a screw 1280 or bolt or nut or other fastener that couples the fastener to the body. Advantageously, an operator can remove or loose the screw 1280 to replace or reorient an insert. In one embodiment, an insert includes a tooth 1270 on opposite ends and an insert can be reoriented such that an opposite tooth 1270 extends from the body 1210 for use in a machining operation.

Advantageously, the single cutting tool 1200 enables machining of a machining feature on both an inside and on an outside surface of a workpiece. The single cutting tool 1200 can remain fixed to the chuck 550 and/or an x-axis plate 650 during the formation/machining a first machining feature on an inside surface of a workpiece and a second machining feature on an outside surface of a workpiece. The single cutting tool 1200 may form both machining features without any adjustments, changes, or repositioning by an operator. Instead, the system 500 may form a first machining feature, return the workpiece and/or system 500 to a zero-return position in all three axes, and then move the cutting tool 1200 along the X-axis, either positive or negative for formation of the second machining feature and commence forming the second machining feature.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles set forth herein.

While specific embodiments and applications of the present disclosure have been illustrated and described, it is to be understood that the scope of this disclosure is not limited to the precise configuration and components disclosed herein. Various modifications, changes, and variations which will be apparent to those skilled in the art may be made in the arrangement, operation, and details of the methods and systems of the present disclosure set forth herein without departing from it spirit and scope.

1. An apparatus for retaining a workpiece, the apparatus comprising:
a first jaw configured to engage a workpiece from a first side of the workpiece;
a second jaw configured to engage the workpiece from a second side of the workpiece, the second side opposite the first side; and
a jaw positioner configured to move at least one of the first jaw and the second jaw laterally to engage and retain the workpiece in a stationary position, the jaw positioner comprising a lateral adjustment apparatus configured to counteract ovality at an end of the workpiece.

2. The apparatus of claim 1, wherein the lateral adjustment apparatus comprises:
a linear actuator configured to extend a jaw and to retract the jaw horizontally along a horizontal x-axis; and
a plurality of fasteners configured to secure a jaw baseplate of the jaw to a slidable jaw member translatable by the jaw positioner.

3. The apparatus of claim 2, wherein the linear actuator is a leadscrew and is configured to move the jaw along the horizontal x-axis towards the center point to increase a lateral force on the workpiece and shorten a major axis that defines ovality at an end of the workpiece.

4. The apparatus of claim 2, wherein the linear actuator is a leadscrew and is configured to move the jaw along the horizontal x-axis away from the center point to decrease a lateral force on the workpiece and increase a minor axis that defines ovality at an end of the workpiece.

5. The apparatus of claim 1, further comprising a vertical adjustment apparatus configured to counteract ovality at an end of the workpiece.

6. The apparatus of claim 5, wherein the jaw positioner comprises a gross adjustment apparatus and a fine adjustment apparatus, the fine adjustment apparatus comprising the vertical adjustment apparatus and the lateral adjustment apparatus.

7. An apparatus for cutting a workpiece, the apparatus comprising:
a programmable controller configured to form a machining feature on a workpiece;
a housing comprising:
a chuck comprising:
a center point;
a vertical y-axis that extends vertically from the center point;
an x-axis that extends horizontally from the center point;
an x-axis plate coupled to the chuck and configured to move laterally relative to the center point and configured to couple to at least one cutting tool;
a first driver coupled to the chuck and configured to rotate the chuck about a z-axis of the chuck in response to a first control signal from the programmable controller, the z-axis extending perpendicular to the x-axis and perpendicular to the y-axis;
a second driver coupled to the x-axis plate and configured to move the x-axis plate laterally relative to the center point in response to a second control signal from the programmable controller;
a third driver configured to move the chuck along the z-axis in response to a third control signal from the programmable controller; and
a vise comprising:
a first jaw configured to engage the workpiece from a first side of the workpiece;
a second jaw configured to engage the workpiece from a second side of the workpiece, the second side opposite the first side; and
a jaw positioner configured to move at least one of the first jaw and the second jaw laterally to engage and retain the workpiece in a stationary position, the jaw positioner comprising a lateral adjustment apparatus configured to counteract ovality at an end of the workpiece.

8. The apparatus of claim 7, wherein the lateral adjustment apparatus comprises:
a linear actuator configured to extend and to retract a jaw horizontally along the x-axis;
a stationary member configured to maintain a position of the linear actuator along the x-axis as the linear actuator operates; and
a plurality of fasteners configured to secure a jaw baseplate of the jaw to a slidable jaw member translatable by the jaw positioner.

9. The apparatus of claim 8, wherein the linear actuator is configured to move the jaw along the x-axis towards the center point to increase a lateral force on the workpiece and shorten a major axis that defines ovality at an end of the workpiece.

10. The apparatus of claim 8, wherein the linear actuator is configured to move the jaw along the x-axis away from the center point to decrease a lateral force on the workpiece and increase a minor axis that defines ovality at an end of the workpiece.

11. The apparatus of claim 7, further comprising a vertical adjustment apparatus configured to counteract ovality at an end of the workpiece.

12. The apparatus of claim 11, wherein the jaw positioner comprises a gross adjustment apparatus and a fine adjustment apparatus, the fine adjustment apparatus comprising the vertical adjustment apparatus and the lateral adjustment apparatus.

13. The apparatus of claim 12, wherein the housing and the vise are coupled to a frame such that the apparatus comprises a single portable unit and wherein the lateral adjustment apparatus and the vertical adjustment apparatus each comprise a mechanical system.

14. The apparatus of claim 12, wherein the gross adjustment apparatus is configured to position the workpiece such that a longitudinal axis of the workpiece is coaxial with the z-axis.

15. The apparatus of claim 7, wherein the first jaw and the second jaw are both coupled to a gross adjustment apparatus of the jaw positioner, such that activation of the gross adjustment apparatus translates both the first jaw and the second jaw together.

16. The apparatus of claim 7, further comprising a frame coupled to the vise and to the housing and to the third driver.

17. The apparatus of claim 7, wherein the x-axis plate is coupled to two or more cutting tools and the programable controller is configured to direct one of the cutting tools to cut into the workpiece for a first stage of a cutting operation and to direct another one of the cutting tools to cut into the workpiece for a second stage of the cutting operation.

18. The apparatus of claim 7, wherein the vise comprises a v-axis that extends through the first jaw and the second jaw and runs parallel to the x-axis, the v-axis configured to represent a zero-return position for the vise.

19. An apparatus for cutting a workpiece, the apparatus comprising:
a programmable controller configured to form a machining feature on a workpiece by following “G” and “M” software executable codes configured for the machining feature;
a housing comprising:
a chuck comprising:
a center point;
a vertical y-axis that extends vertically from the center point;
a horizontal x-axis that extends horizontally from the center point;
an x-axis plate coupled to the chuck and configured to move laterally relative to the center point and configured to couple to a cutting tool configured to form the machining feature;
a first driver coupled to the chuck and configured to rotate the chuck about a z-axis of the chuck in response to a first control signal from the programmable controller, the z-axis extending perpendicular to the x-axis and perpendicular to the y-axis;
a second driver coupled to the x-axis plate and configured to move the x-axis plate laterally relative to the center point in response to a second control signal from the programmable controller;
a third driver configured to move the chuck along the z-axis in response to a third control signal from the programmable controller;
a vise comprising:
a first jaw configured to engage the workpiece from a first side of the workpiece;
a second jaw configured to engage the workpiece from a second side of the workpiece, the second side opposite the first side;
a gross adjustment apparatus configured to move the first jaw and the second jaw laterally to engage and retain the workpiece in a stationary position;
a fine adjustment apparatus configured to counteract ovality at an end of the workpiece, the fine adjustment apparatus comprising:
a vertical adjustment apparatus configured to adjust a grip of the vise on the workpiece along the y-axis;
a lateral adjustment apparatus configured to adjust the grip of the vise on the workpiece along the x-axis.

20. The apparatus of claim 19, wherein the vertical adjustment apparatus comprises a first vertical adjustment apparatus configured to adjust the first jaw independent of a second vertical adjustment apparatus configured to adjust the second jaw.
